(19) United States
(12) Patent Application Publication
(10) Pub. No.: US 2009/0179974 A1
(43) Pub. Date: Jul. 16, 2009

(54) LIQUID SUPPLY SYSTEM, LIQUID SUPPLY SOURCE AND LIQUID EJECTING APPARATUS

(75) Inventor: Hitotoshi KIMURA, Matsumoto-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/354,507

(22) Filed: Jan. 15, 2009

(30) Foreign Application Priority Data
Jan. 16, 2008 (JP) 2008-007094
Jan. 16, 2008 (JP) 2008-007095
Jan. 24, 2008 (JP) 2008-013535
Jan. 24, 2008 (JP) 2008-013536
Jan. 24, 2008 (JP) 2008-013537
Nov. 6, 2008 (JP) 2008-285198

(51) Int. Cl. B41J 2/175

(52) U.S. Cl. 347/85

(57) ABSTRACT

A liquid supply system includes a liquid supply source with a liquid container portion accommodating liquid inside and a liquid delivery portion that delivers the liquid outside. A liquid supply flow passage supplies the liquid from an upstream side of the liquid supply source, toward a downstream side at which the liquid is consumed. A pump is driven using a portion of the liquid supply flow passage as a pump chamber. A first one-way valve in the liquid supply flow passage at a position downstream of the pump chamber allows the liquid to pass only from the upstream side to the downstream side. A second one-way valve in the liquid supply source allows the liquid to pass only from an upstream side of the liquid container portion, to a downstream side of the liquid delivery portion.

The entire disclosure of Japanese Patent Application No. 2008-007094, filed Jan. 16, 2008 Japanese Patent Application No. 2008-007095, filed Jan. 16, 2008 Japanese Patent Application No. 2008-013535, filed Jan. 24, 2008 Japanese Patent Application No. 2008-013536, filed Jan. 24, 2008 Japanese Patent Application No. 2008-013537, filed Jan. 24, 2008 and Japanese Patent Application No. 2008-285198, filed Nov. 6, 2008, are expressly incorporated herein by reference.

### BACKGROUND

1. Technical Field

The invention relates to a liquid supply system, liquid supply source and liquid ejecting apparatus that include a one-way valve that only allows liquid to pass from an upstream side, which is a liquid supply source side, to a downstream side at which the liquid is consumed.

2. Related Art

An ink jet recording apparatus (hereinafter, referred to as “printer”) is widely known as one of existing liquid ejecting apparatuses. The printer ejects ink, which is supplied from a liquid supply source, such as an ink bag accommodated in an ink cartridge (hereinafter, referred to as “cartridge”), from a liquid ejecting head onto a target to thereby perform printing. In such a printer, when the inside of the cartridge is pressurized to pump ink, there is a possibility that, when ink is supplied from the cartridge side, pressurized ink may leak outside from the inside of an ink supply passage.

Then, a printer described in JP-A-2006-272661 includes a pump having an ink introducing chamber (pump chamber) and a working fluid introducing chamber, which are partitioned by a diaphragm, and, in addition, includes a vacuuming one-way valve at an upstream side of the ink introducing chamber and a delivery one-way valve at a downstream side of the ink introducing chamber. The vacuuming one-way valve and delivery one-way valve each only allow ink to pass from the upstream side to the downstream side. Then, the pump displaces the diaphragm so as to increase the volume of the ink introducing chamber on the basis of a variation in pressure of the working fluid supplied from a working fluid supply source to a working fluid introducing chamber. Thus, the pump vacuums the ink from the cartridge side through the vacuuming one-way valve to the ink introducing chamber. After vacuuming the ink, the pump displaces the diaphragm so as to reduce the volume of the ink introducing chamber. Thus, the pump pressurizes and supplies the ink through the delivery one-way valve to the liquid ejecting head side.

In addition, there is a need for smoothly supplying ink to the liquid ejecting head side and detecting ink level in the cartridge, so JP-A-9-164698 and JP-A-5-88552 describe the configuration for ink level detection. With these techniques, ink level may be checked and then printing is performed, so it is possible to reduce occurrence of ink out, or the like, during printing.

Incidentally, the printer described in JP-A-2006-272661 includes the vacuuming one-way valve for vacuuming ink into the ink introducing chamber, which serves as a pump chamber, inside an ink supply device, which supplies ink from the detachably connected cartridge side to the liquid ejecting head side. Then, the printer opens and closes the vacuuming one-way valve each time the pump of the ink supply device is driven for supplying ink. For this reason, the above printer is required to have a high durability so that the vacuuming one-way valve sufficiently withstands repeated driving of the pump in the ink supply device.

In addition, in the ink level detection, the configuration described in JP-A-9-164698 needs additional space for installing an ink level detecting unit and, therefore, it is unsuitable for reducing the size of the printer. Then, in the configuration described in JP-A-5-88552, because ink level is calculated on the basis of the number of times of discharging, it does not require space for installing an ink level detecting unit; however, this configuration may easily cause a deviation between the calculated ink level and an actual ink level. Furthermore, in these JP-A-2006-272661, JP-A-9-164698 and JP-A-5-88552, employment of a variable pressure by which ink is supplied to the liquid ejecting head is not taken into consideration, so it is difficult to smoothly supply various types of ink while handling thickening, or the like, of the ink.

### SUMMARY

An advantage of some aspects of the invention is that it provides a liquid supply system that is able to improve the flexibility of design in such a manner that a vacuuming one-way valve that only allows liquid to pass from an upstream side, which is a liquid supply source side when a pump is driven, to a downstream side, which is a pump side, is made applicable with a simple configuration that does not require high durability. In addition, another advantage of some aspects of the invention is that it provides a liquid supply source that is connected to the liquid supply system and a liquid ejecting apparatus that includes the liquid supply system.

Aspects of the invention may be implemented as the following application examples or embodiments.

### First Application Example

A liquid supply system according to the present application example includes: a liquid supply source that has a liquid container portion that accommodates liquid inside and a liquid delivery portion that delivers the liquid outside; a liquid supply flow passage that supplies the liquid from an upstream side, which is a side of the liquid supply source, toward a downstream side at which the liquid is consumed; a pump that is driven using portion of the liquid supply flow passage as a pump chamber; a first one-way valve that is provided in the liquid supply flow passage at a position downstream of the pump chamber and that only allows the liquid to pass from the upstream side to the downstream side; and a second one-way valve that is provided in the liquid supply source and that only allows the liquid to pass from an upstream side, which is a side of the liquid container portion, to a downstream side, which is a side of the liquid delivery portion.

With the above configuration, the vacuuming second one-way valve is provided in the liquid supply source. The vacuuming second one-way valve opens during vacuum driving by which the pump vacuums the liquid from the liquid supply source side into the pump chamber, and closes during discharge driving by which the pump pressurizes and supplies the liquid, vacuumed into the pump chamber, to the downstream side. Thus, when the liquid supply source is detached for replacement, for example, in the case of a liquid end state, or the like, the vacuuming second one-way valve is also replaced at the same time and, therefore, the vacuuming second one-way valve only needs to have durability until the liquid supply source is replaced. That is, when the vacuuming second one-way valve is provided in the liquid supply source, it may be applied as a component of the liquid supply system even with a simple configuration that does not require high durability. Thus, the vacuuming one-way valve that only allows the liquid to pass from the upstream side, which is a side of the liquid supply source, to the downstream side, which is a side of the pump, during driving of the pump may be applied even with a simple configuration that does not require high durability, so it is possible to increase the flexibility of design.

### Second Application Example

In the liquid supply system according to the above application example, any one of a differential pressure regulating valve or a pressure reducing valve may be provided in the liquid supply source between the liquid container portion and the liquid delivery portion, wherein the differential pressure regulating valve may switch between open/closed states on the basis of a differential pressure between a liquid pressure on the side of the liquid container portion and a liquid pressure on the side of the liquid delivery portion, wherein the pressure reducing valve may switch between open/closed states on the basis of a negative pressure applied from a downstream side to the side of the liquid delivery portion inside the liquid supply source, and wherein the second one-way valve may double as the differential pressure regulating valve or may double as the pressure reducing valve.

With the above configuration, when the liquid contained in the liquid supply source is delivered outside, the differential pressure regulating valve or the pressure reducing valve switches between the open/closed states of the liquid supply flow passage. That is, the differential pressure regulating valve or the pressure reducing valve, during vacuum driving of the pump, opens on the basis of the action of a negative pressure from the downstream side, which is a side of the pump, to thereby allow the liquid to pass from the upstream side to the downstream side. On the other hand, the differential pressure regulating valve or the pressure reducing valve, during discharge driving of the pump, closes on the basis of the action of a positive pressure from the downstream side, which is a side of the pump, to thereby restrict backflow of the liquid from the downstream side to the upstream side. In other words, the differential pressure regulating valve or the pressure reducing valve doubles as the vacuuming second one-way valve during driving of the pump. Thus, it is not necessary to further assemble a second one-way valve separately from the differential pressure regulating valve or the pressure reducing valve. Hence, by reducing the number of components that constitute the liquid supply source, it is possible to improve the assembling efficiency and reduction in manufacturing cost.

### Third Application Example

In the liquid supply system according to the above application example, any one of a differential pressure regulating valve or a pressure reducing valve may be provided in the liquid supply source between the liquid container portion and the liquid delivery portion, wherein the differential pressure regulating valve may switch between open/closed states on the basis of a differential pressure between a liquid pressure on the side of the liquid container portion and a liquid pressure on the side of the liquid delivery portion, wherein the pressure reducing valve may switch between open/closed states on the basis of a negative pressure applied from a downstream side to the side of the liquid delivery portion inside the liquid supply source, and wherein the second one-way valve may be provided in the liquid supply source between the liquid delivery portion and the differential pressure regulating valve or in the liquid supply source between the liquid delivery portion and the pressure reducing valve.

With the above configuration, the differential pressure regulating valve or the pressure reducing valve that adjusts the delivery pressure of the liquid contained in the liquid supply source is arranged at a position upstream of the second one-way valve that only allows the liquid to pass from the side of the liquid container portion to the side of the liquid delivery portion inside the liquid supply source. Thus, the second one-way valve restricts backflow of the liquid from the side of the liquid supply flow passage through the liquid delivery portion to thereby make it possible to suppress interference of a variation in liquid pressure in the liquid supply flow passage side with the characteristic of the differential pressure regulating valve or pressure reducing valve through the liquid delivery portion.

### Fourth Application Example

In the liquid supply system according to the above application example, a flow passage opening/closing valve that is able to open and close the liquid supply flow passage may be provided in the liquid supply flow passage between the pump chamber and the liquid delivery portion of the liquid supply source.

With the above configuration, the flow passage opening/closing valve is arranged at a position upstream of the liquid supply flow passage formed in the liquid supply device connected to the liquid supply source. Thus, even when the liquid supply source is detached from the liquid supply device, by closing the flow passage opening/closing valve, it is possible to suppress leakage of the liquid from the opening portion upstream of the liquid supply flow passage in the liquid supply device.

### Fifth Application Example

In the liquid supply system according to the above application example, the liquid supply source may be a flexible liquid container bag, and an inner closed space of the liquid container bag may be the liquid container portion.

With the above configuration, it is possible to obtain the liquid supply source in which the liquid container portion of the closed space that contains the liquid varies in volume in accordance with the liquid level with a simple configuration.

### Sixth Application Example

In the liquid supply system according to the above application example, the liquid supply source may have an atmospheric communication hole that communicates the liquid container portion with the atmosphere.

With the above configuration, it is possible to obtain the liquid supply source that applies a certain pressure from the outside to the closed-space liquid container portion that contains the liquid with a simple configuration.

### Seventh Application Example

A liquid supply source according to the above application example includes a liquid container portion that accommodates liquid inside and a liquid delivery portion that delivers the liquid outside, and the liquid delivery portion is connected to an upstream side of the liquid supply flow passage in the above configured liquid supply system.

With the above configuration, the similar advantageous effects to those of the aspects of the invention of the liquid supply system may be obtained.

### Eighth Application Example

A liquid ejecting apparatus according to the present application example includes a liquid ejecting head that ejects liquid and the above described liquid supply system that supplies the liquid to the liquid ejecting head.

With the above configuration, the similar advantageous effects to those of the aspects of the invention of the liquid supply system may be obtained.

### BRIEF DESCRIPTION OF THE DRAWINGS

The invention will be described with reference to the accompanying drawings, wherein like numbers reference like elements.

FIG. 1 is a schematic view of a liquid ejecting apparatus according to a first embodiment.

FIG. 2 is a schematic view of the liquid ejecting apparatus when a pump is driven for vacuuming.

FIG. 3 is a schematic view of the liquid ejecting apparatus when the pump is driven for discharging.

FIG. 4 is a schematic view of an ink cartridge according to a second embodiment.

FIG. 5 is a schematic view of an ink cartridge according to a third embodiment.

FIG. 6 is a schematic view of a liquid ejecting apparatus according to a fifth embodiment.

FIG. 7 is a schematic view of the liquid ejecting apparatus when a pump is driven for vacuuming.

FIG. 8 is a schematic view of the liquid ejecting apparatus when the pump is driven for discharging.

FIG. 9 is a schematic view of a liquid ejecting apparatus according to a sixth embodiment.

FIG. 10 is a schematic view of the liquid ejecting apparatus when a pump is driven for discharging.

FIG. 11 is a schematic view of the liquid ejecting apparatus when a liquid reservoir portion discharges liquid.

FIG. 12 is a schematic view of the liquid ejecting apparatus when the pump is driven for vacuuming.

FIG. 13A is a cross-sectional view of the liquid reservoir portion when the pump is driven for discharging.

FIG. 13B is a cross-sectional view of the liquid reservoir portion when the pump is driven for vacuuming.

FIG. 14 is a schematic view of a liquid ejecting apparatus according to a seventh embodiment.

FIG. 15 is a schematic view of the liquid ejecting apparatus when a liquid supply device is driven for discharging.

FIG. 16 is a schematic view of the liquid ejecting apparatus when the liquid supply device is driven for vacuuming.

FIG. 17A is a cross-sectional view of the liquid reservoir portion when the liquid supply device is driven for vacuuming.

FIG. 17B is a cross-sectional view of the liquid reservoir portion when the liquid supply device is driven for discharging.

FIG. 18 is a schematic view of a liquid ejecting apparatus according to an eighth embodiment.

FIG. 19 is a schematic view of the liquid ejecting apparatus when a liquid supply device is driven for vacuuming.

FIG. 20A is a cross-sectional view of a liquid reservoir portion when the liquid supply device is driven for discharging.

FIG. 20B is a cross-sectional view of the liquid reservoir portion when the liquid supply device is driven for vacuuming.

### DESCRIPTION OF EXEMPLARY EMBODIMENTS

### First Embodiment

Hereinafter, an ink jet printer (hereinafter, referred to as “printer”) according to a first embodiment of the invention will be described with reference to the accompanying drawings.

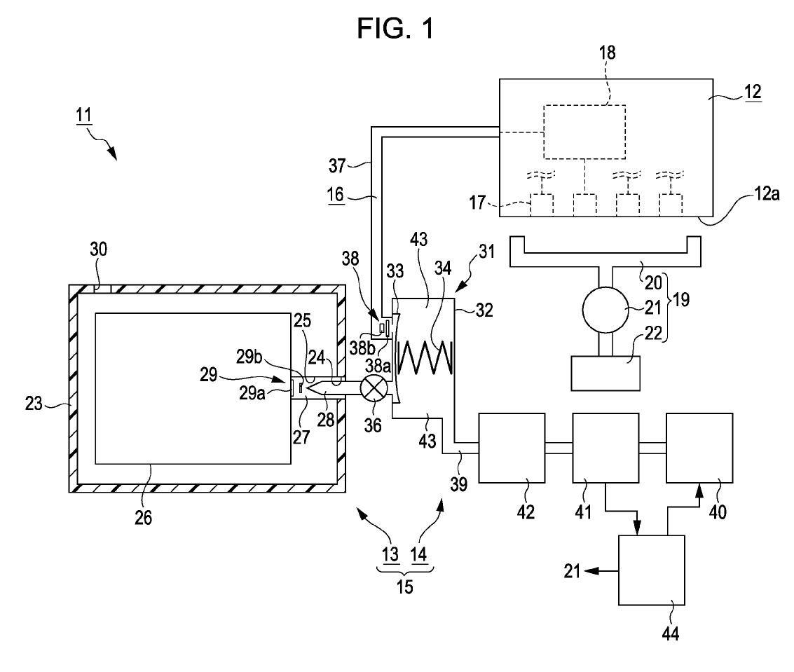

As shown in FIG. 1, the printer 11, which serves as a liquid ejecting apparatus in the first embodiment, includes a recording head 12 and an ink supply device 14. The recording head 12 serves as a liquid ejecting head that ejects ink (liquid) to a target (not shown). The ink supply device 14 serves as a liquid supply device that supplies ink, contained in an ink cartridge 13 serving as a liquid supply source, to the recording head 12. Then, the ink cartridge 13 and the ink supply device 14 constitute an ink supply system 15, which serves as a liquid supply system. An ink flow passage 16 (liquid supply flow passage) is provided for the ink supply device 14. The upstream end of the ink flow passage 16 is connected to the ink cartridge 13, and the downstream end of the ink flow passage 16 is connected to the recording head 12. In such a state, the ink flow passage 16 supplies ink from an upstream side, which is an ink cartridge 13 side, to a downstream side, which is a recording head 12 side.

Note that the printer 11 includes a plurality of the ink supply devices 14 in correspondence with the number of colors (types) of inks used in the printer 11. However, because their configurations are similar, FIG. 1 shows one ink supply device 14 that supplies any one of colors together with the recording head 12 and one ink cartridge 13. Then, the following description provides an example in which ink is supplied from the upstream-side ink cartridge 13 to the downstream-side recording head 12 through the ink flow passage 16 of the one ink supply device 14 shown in FIG. 1.

As shown in FIG. 1, the recording head 12 has a plurality of nozzles 17 (four in the first embodiment) corresponding to the number of the installed ink supply devices 14 at a nozzle forming surface 12a that faces a platen (not shown). Then, ink is supplied from the ink flow passage 16 of the ink supply device 14 corresponding to each of the nozzles 17 through a valve unit 18. That is, the valve unit 18 has a pressure chamber (not shown) that temporarily stores ink flowing from the ink flow passage 16 so as to communicate with the nozzle 17, and when ink is ejected from the nozzle 17, ink of an amount corresponding to the amount of ink consumed by the ink ejection appropriately flows from the ink flow passage 16 into the pressure chamber on the basis of opening/closing operations of a valve (not shown).

In addition, in the printer 11, a maintenance unit 19 is provided at a home position at which the recording head 12 is located when printing is not performed. The maintenance unit 19 cleans the recording head 12 in order to remove clogging, or the like, of the nozzles 17 of the recording head 12. The maintenance unit 19 includes a cap 20, a vacuum pump 21, and a waste liquid tank 22. The cap 20 is able to contact the nozzle forming surface 12a of the recording head 12 so as to surround the nozzles 17. The vacuum pump 21 is driven when ink is vacuumed from the inside of the cap 20. The waste liquid tank 22 receives ink vacuumed and drained from the inside of the cap 20 as waste ink by driving the vacuum pump 21. Then, during cleaning, in a state where the cap 20 is moved and is in contact with the nozzle forming surface 12a of the recording head 12, the vacuum pump 21 is driven to generate a negative pressure inside the cap 20. Thus, thickened ink containing bubbles is vacuumed and drained from the inside of the recording head 12 to the waste liquid tank 22. Note that the driving state of the vacuum pump 21 is controlled by a controller 44.

On the other hand, the ink cartridge 13 includes a case 23 made of synthetic resin material and formed into substantially a box shape. An ink delivery port 24 is formed in the side wall of the case 23 and serves as a liquid delivery portion for delivering ink outside, and a communication portion 25 is formed through the side wall of the case 23 so as to communicate from the ink delivery port 24 with the inside of the case 23. The communication portion 25 serves as an ink flow passage. In addition, an ink bag 26 is accommodated in the case 23. The ink bag 26 is made of a flexible liquid container bag and encloses (contains) ink inside a closed space, which serves as a liquid container portion. Furthermore, a cylindrical ink delivery member 27 is provided at one end of the ink bag 26 for delivering ink, enclosed inside, to the outside. By fitting the ink delivery member 27 into the communication portion 25 of the case 23, the ink bag 26 is fixed to an accommodating position inside the ink cartridge 13. Then, when the ink cartridge 13 is connected to the ink supply device 14, an ink supply needle 28, which protrudes from the ink supply device 14 to form the upstream end of the ink flow passage 16, is inserted into the ink delivery port 24. At this time, the periphery of the ink supply needle 28 is sealed by a seal member (not shown) in the ink delivery port 24. Note that a vacuuming second one-way valve 29 is provided inside the ink delivery member 27. The second one-way valve 29 only allows ink to pass from an upstream side, which is an ink bag 26 side, to a downstream side, which is an ink delivery port 24 side. The second one-way valve 29 includes a valve element 29a and a retainer portion 29b. The valve element 29a reciprocally and horizontally moves between an open valve position and a closed valve position in accordance with a variation in ink pressure and flow of ink. The retainer portion 29b retains the valve element 29a that moves in a direction to open the valve. In addition, an atmospheric communication hole 30 is formed through the upper wall of the case 23 so as to communicate the inside of the case 23 with the atmosphere. Thus, atmospheric pressure is applied on the outer surface of the ink bag 26 that contains ink.

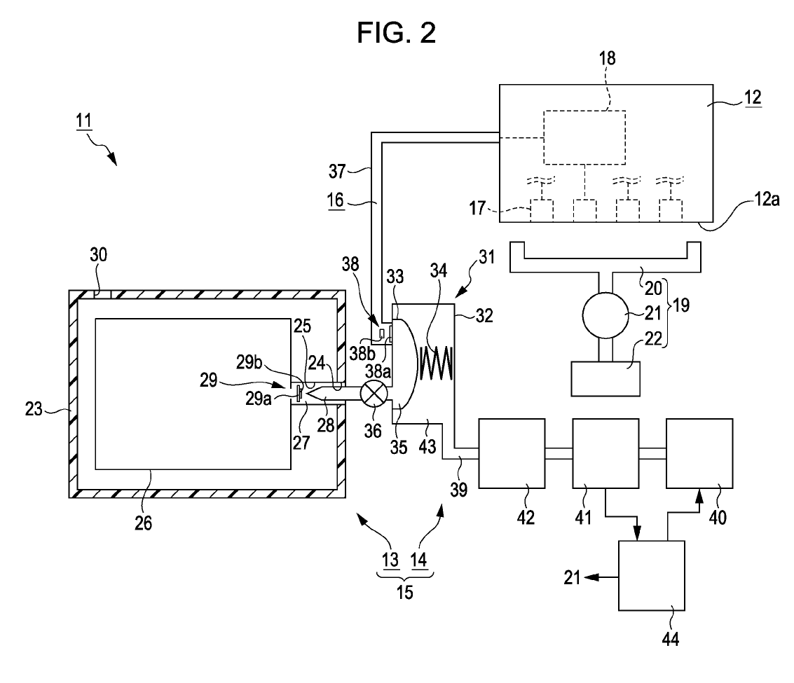

Next, the configuration of the ink supply device 14 will be described in detail. As shown in FIG. 1, the ink supply device 14 includes a pump 31 that pressurizes and supplies ink vacuumed from the ink cartridge 13 side through the ink flow passage 16 to the recording head 12 side. The pump 31 has substantially a box-shaped pump case 32. The inside of the pump case 32 is partitioned into two right and left chambers by a diaphragm 33. In addition, the diaphragm 33 is urged toward the left-side wall surface of the pump case 32 by the urging force of a coil spring 34 that is held between the diaphragm 33 and the right-side wall surface of the pump case 32. Then, in the first embodiment, these pump case 32, diaphragm 33 and coil spring 34 constitute a pulsating pump 31, and a variable volume space, which is surroundingly defined by the diaphragm 33 and the left-side wall surface of the pump case 32, serves as a pump chamber 35 (FIG. 2) in the pump 31. Note that a flow passage opening/closing valve 36, which is able to open and close the ink flow passage 16, is provided at a position upstream of the pump chamber 35 in the ink flow passage 16.

In addition, one end (upstream end) of an ink supply tube 37, which constitutes portion of the ink flow passage 16 in the ink supply device 14, is connected to the pump chamber 35, and the other end (downstream end) of the ink supply tube 37 is connected to the recording head 12 side valve unit 18. Then, a discharging first one-way valve 38 is provided at a position at which the pump 31 is connected to the ink supply tube 37. The first one-way valve 38 only allows ink to flow from the upstream side, which is a pump chamber 35 side, to the downstream side, which is a recording head 12 side. The first one-way valve 38, as in the case of the second one-way valve 29, includes a valve element 38a and a retainer portion 38b. The valve element 38a is able to reciprocally and horizontally move between an open valve position and a closed valve position in accordance with a variation in ink pressure and flow of ink. The retainer portion 38b retains the valve element 38a that moves in a direction to open the valve.

In addition, a vacuum pump 40, a pressure detector 41 and an atmospheric relief valve 42 are connected through an air flow passage 39 to the bottom wall of the pump case 32. That is, the vacuum pump 40 is connected through the air flow passage 39 to a space that serves as a volume-variable negative pressure chamber 43 surroundingly defined by the diaphragm 33 and the right-side wall surface of the pump case 32. Then, the vacuum pump 40 is driven to generate a negative pressure, and also generates a negative pressure in the negative pressure chamber 43 that is connected through the air flow passage 39 to the vacuum pump 40. In addition, the pressure detector 41 detects a pressure in the negative pressure chamber 43 connected through the air flow passage 39, and outputs the detected pressure to the controller 44. Then, the controller 44, when the pressure in the negative pressure chamber 43 is lower than a predetermined threshold by driving the vacuum pump 40, stops driving of the vacuum pump 40, and opens the atmospheric relief valve 42 to open the inside of the negative pressure chamber 43 to the atmosphere to thereby eliminate a negative pressure state.

Note that FIG. 1 illustrates the configuration in which the vacuum pump 40, the pressure detector 41 and the atmospheric relief valve 42 are provided one by one for each of the plurality of ink supply devices 14 corresponding to the individual ink colors; however, it may be configured as follows. That is, the connecting end of the air flow passage 39, which is connected to the negative pressure chamber 43 of the pump 31 of the ink supply device 14, may be branched off so as to correspond to the number of the plurality of installed ink supply devices 14 corresponding to the individual ink colors, and the connecting end of each branched air flow passage 39 may be connected to a corresponding one of the pumps 31 of the ink supply devices 14. With this configuration, only by providing a single vacuum pump 40, pressure detector 41 and atmospheric relief valve 42 for the plurality of ink supply devices 14, it is possible to drive the ink supply devices 14 of the respective colors, and the size of the printer 11 may be reduced.

Then, next, the operation of the thus configured printer 11 will be described particularly focusing on the operation of the ink supply device 14. First, it is assumed that FIG. 1 shows a state immediately after replacement to a new ink cartridge 13, the diaphragm 33 of the pump 31 is displaced to the left-side wall surface side of the pump case 32 by the urging force of the coil spring 34, and the atmospheric relief valve 42 is closed.

Then, in the state shown in FIG. 1, when the ink supply device 14 supplies ink from the ink cartridge 13 to the recording head 12 side, first, the vacuum pump 40 is driven for driving the pump 31. After that, the vacuum pump 40 generates a negative pressure, and the negative pressure chamber 43 of the pump 31, connected to the vacuum pump 40 through the air flow passage 39, is placed in a negative pressure state. Thus, the diaphragm 33 is elastically deformed (displaced) toward the negative pressure chamber 43 against the urging force of the coil spring 34 to reduce the volume of the negative pressure chamber 43. Then, with the reduction in volume of the negative pressure chamber 43, the pump chamber 35 of the pump 31 partitioned by the diaphragm 33 from the negative pressure chamber 43 increases in volume conversely.

With the increase in volume of the pump chamber 35, the inside of the pump chamber 35 is placed in a negative pressure state, and then the negative pressure is applied from the downstream side through the ink supply needle 28 to the valve element 29a that constitutes the second one-way valve 29. Then, on the basis of a differential pressure with respect to an ink pressure applied from the ink bag 26 side, which is the upstream side of the second one-way valve 29, the valve element 29a is displaced rightward (in a direction to open the valve). As a result, the inside of the ink bag 26 communicates with the pump chamber 35 and, therefore, ink contained in the ink bag 26 is vacuumed into the pump chamber 35 through the ink supply needle 28. That is, the pump 31 is driven for vacuuming.

On the other hand, when the pump 31 is driven for vacuuming, the negative pressure in the pump chamber 35 is also applied to the upstream side of the first one-way valve 38. Here, the inside of the pump chamber 35 is lower in pressure than that of the inside of the ink supply tube 37, and then the first one-way valve 38 enters a valve closed state in such a manner that the valve element 38a moves rightward on the basis of a differential pressure between the inside of the pump chamber 35 and the inside of the ink supply tube 37.

Thereafter, in the state shown in FIG. 2, in order to determine whether the pump 31 initiates discharge driving, the pressure detector 41 detects a pressure accumulated in the negative pressure chamber 43 by driving the vacuum pump 40. Then, the controller 44 determines that the volume of the pump chamber 35 is maximal at the time when the detected pressure reaches a predetermined threshold, and stops driving of the vacuum pump 40 to initiate discharge driving of the pump 31, while opening the atmospheric relief valve 42 to open the negative pressure chamber 43, placed in a negative pressure state, to the atmosphere. Then, the diaphragm 33 of the pump 31 is urged to the pump chamber 35 side by the coil spring 34.

That is, the pump 31 urges the diaphragm 33 in a direction to reduce the volume of the pump chamber 35. Thus, a pressure is applied to the ink inside the pump chamber 35, and the applied pressure acts from the downstream side to the valve element 29a that constitutes the second one-way valve 29 through the ink flow passage 16 on the upstream side with respect to the pump chamber 35 to thereby displace the valve element 29a in a direction to close the valve. As a result, the inside of the ink bag 26 is disconnected from the ink flow passage 16 due to the valve closing operation of the second one-way valve 29, and vacuuming of ink from the ink cartridge 13 to the pump chamber 35 through the second one-way valve 29 is stopped, while, in accordance with discharge driving of the pump 31, ink discharged from the pump chamber 35 is restricted from flowing back through the second one-way valve 29 to the ink cartridge 13 side.

On the other hand, when the pump 31 applies pressure, the pressure of ink in the pump chamber 35 also acts on the upstream side of the first one-way valve 38. Thus, the discharge pressure of the pump 31 causes the closed valve element 38a to perform a valve opening operation, and, therefore, the pump chamber 35 communicates with the inside of the ink supply tube 37 through the first one-way valve 38. As a result, ink is pressurized and supplied from the pump chamber 35 through the ink supply tube 37 to the valve unit 18.

Then, after that, the discharge pressure of ink discharged from the pump chamber 35 by being pressurized by the diaphragm 33 is uniformly applied to the flow passage regions downstream of the second one-way valve 29 in the ink flow passage 16, and this state is maintained. After that, as ink is ejected from the recording head 12 toward the target, ink of an amount corresponding to the amount of ink consumed by the ink ejection is supplied from the inside of the ink flow passage 16 through the valve unit 18 to the recording head 12 side. Thus, with the ink consumption at the downstream side (recording head 12 side), ink of an amount corresponding to the amount consumed is supplied under pressure to the downstream side, which is the recording head 12 side, on the basis of the pressing force of the diaphragm 33 that is urged by the urging force of the coil spring 34 in a direction to reduce the volume of the pump chamber 35. Note that the inside of the pump chamber 35 is pressurized by the urging force of the coil spring 34, so it is possible to maintain the pressurized state without providing an additional device for pressurizing the inside of the pump chamber 35. In addition, when a device that has both the function of a pressure generating device and the function of a negative pressure generating device is employed as a driving source for the pump 31, a complex control configuration for maintaining the pressurized state inside the pump chamber 35 is necessary; however, when the coil spring 34 is employed as a driving source for the pump 31, it is possible to simply maintain the pressurized state inside the pump chamber 35.

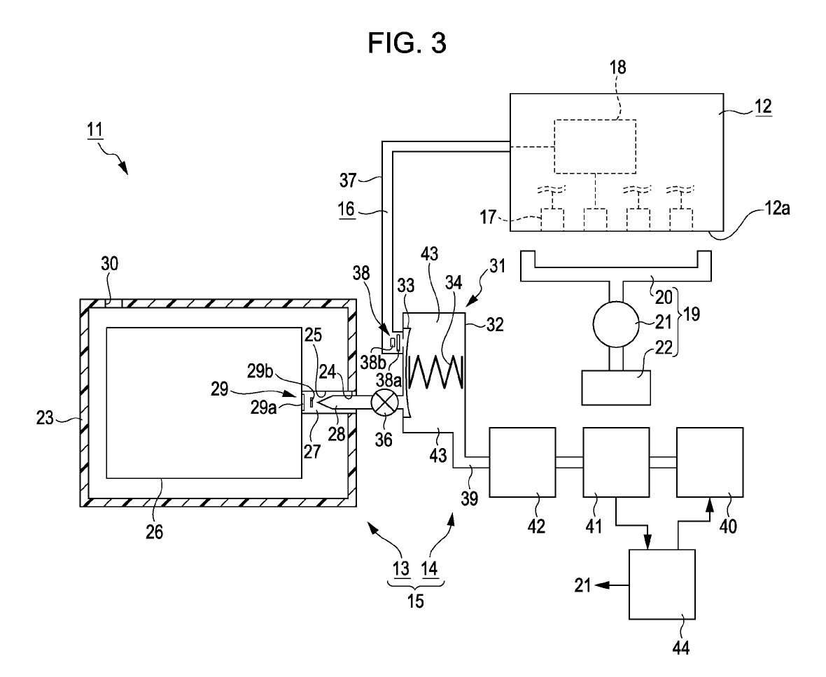

Then, as a result of consumed ink, the volume in the pump chamber 35 gradually reduces, and finally the diaphragm 33 is displaced to near a position at which the diaphragm 33 contacts the left-side wall surface of the pump case 32 so that the volume of the pump chamber 35 is minimal (FIG. 3). In this state, because ink cannot be supplied to the recording head 12 side, the controller 44 operates the atmospheric relief valve 42 to open and then drives the vacuum pump 40 again. By so doing, the vacuum pump 40 generates a negative pressure to place the negative pressure chamber 43 in a negative pressure state, and the diaphragm 33 is elastically deformed (displaced) to the negative pressure chamber 43 side against the urging force of the coil spring 34. That is, the pump 31 initiates vacuum driving again.

As a result, when the diaphragm 33 displaces in a direction to increase the volume of the pump chamber 35, the inside of the pump chamber 35 is placed in a negative pressure state, so the valve element 29a that constitutes the second one-way valve 29 moves in a direction to open the valve by the action of the negative pressure. Thus, the inside of the ink bag 26 communicates with the ink flow passage 16 through the second one-way valve 29, and ink is vacuumed from the inside of the ink bag 26 to the inside of the pump chamber 35 again. After that, the pump 31 is driven for discharging as in the above manner, and ink is pressurized and supplied from the inside of the pump chamber 35 through the ink supply tube 37 to the recording head 12.

Incidentally, in the printer 11, the second one-way valve 29 and the first one-way valve 38 that are respectively provided upstream and downstream of the pump chamber 35 alternately switch an opening/closing state in association with the cycle of the vacuum driving and discharge driving of the pump 31. That is, with the repeated driving of the pump 31, each of the one-way valves 29 and 38 repeats opening and closing operations, and this frequent opening and closing operations may cause breakage or degradation. Then, the discharging first one-way valve 38 arranged in the ink flow passage 16 inside the printer 11 has high durability to withstand repeated driving of the pump 31 for a long period of time in order to maintain the performance of ink supply in the printer 11 for a long period of time.

On the other hand, the vacuuming second one-way valve 29 arranged upstream of the pump chamber 35 is provided inside the ink cartridge 13 that is detached for replacement from the printer 11 in the case of an ink end state, or the like. Thus, the vacuuming second one-way valve 29 is replaced at the same time with detaching the ink cartridge 13 for replacement, so the second one-way valve 29 only needs to have durability such that the printer 11 normally operates during usage of one ink cartridge 13. Thus, in comparison with the case in which the second one-way valve 29 is provided for the ink supply device 14 in the printer 11, the requirement of durability for the second one-way valve 29 is reduced and, therefore, it is possible to apply a further simple configuration to the second one-way valve 29. Then, the second one-way valve 29 is replaced with a new one each time the ink cartridge 13 is detached for replacement, so it is possible to improve reliability of the performance of ink supply of the printer 11.

According to the first embodiment, the following advantageous effects may be obtained.

(1) In the first embodiment, the vacuuming second one-way valve 29 is provided inside the ink cartridge 13. The vacuuming second one-way valve 29 opens during vacuum driving by which the pump 31 vacuums ink from the ink cartridge 13 side to the inside of the pump chamber 35, and closes during discharge driving by which the pump 31 pressurizes and supplies ink, vacuumed to the inside of the pump chamber 35, to the downstream side. Thus, when the ink cartridge 13 is detached for replacement, for example, in the case of an ink end state, or the like, the vacuuming second one-way valve 29 is also replaced at the same time and, therefore, the vacuuming second one-way valve 29 only needs to have durability until the ink cartridge 13 is replaced. In other words, when the vacuuming second one-way valve 29 is provided inside the ink cartridge 13, it is possible to sufficiently exercise the function as a component of the ink supply system even with a simple configuration that does not require high durability. Thus, it is possible to improve the flexibility of design in regard to the second one-way valve 29.

(2) The flow passage opening/closing valve 36 is arranged at a position upstream of the ink flow passage 16 formed in the ink supply device 14 that is connected to the ink cartridge 13 so as to be able to open and close the ink flow passage 16. Thus, even when the ink cartridge 13 is detached from the ink supply device 14, by closing the flow passage opening/closing valve 36, it is possible to suppress leakage of ink from the opening (that is, the ink supply needle 28) upstream of the ink flow passage 16 in the ink supply device 14.

(3) The ink cartridge 13 accommodates the flexible ink bag 26 inside, and the ink bag 26 contains ink inside (closed-space liquid container portion). Thus, it is possible to obtain the liquid supply source (ink cartridge 13) in which the closed-space liquid container portion that contains liquid (ink) varies in volume in accordance with the liquid (ink) level with a simple configuration.

(4) In the above embodiment, the ink cartridge 13 has the atmospheric communication hole 30 that makes the inside of the case 23 accommodating the ink bag 26 communicate with the atmosphere. Thus, it is possible to obtain the ink cartridge 13 that externally applies a certain pressure to the ink bag 26 containing ink with a simple configuration.

### Second Embodiment

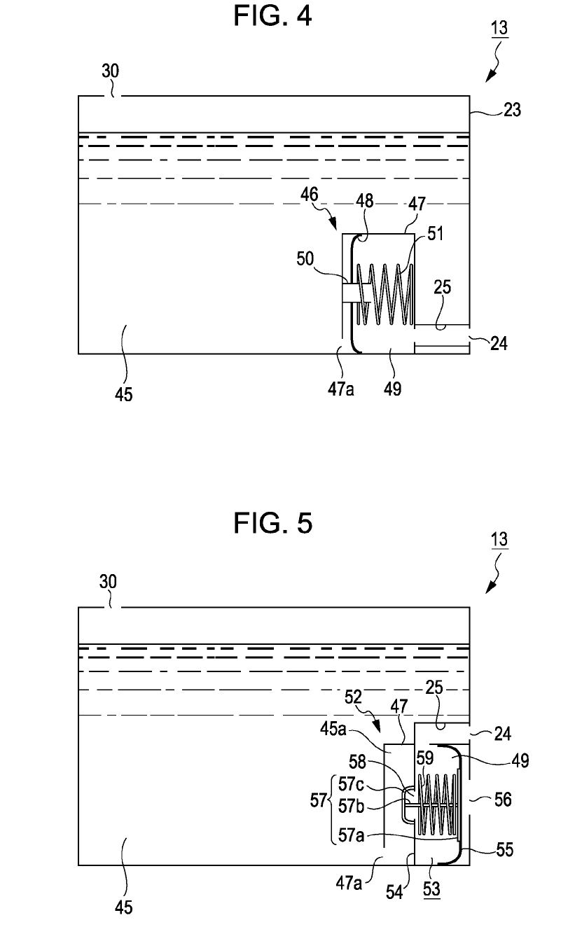

Next, a second embodiment of the invention will be described with reference to FIG. 4. Note that the second embodiment differs from the first embodiment in the following configuration. That is, no second one-way valve 29 (FIG. 1) according to the first embodiment is provided inside the ink cartridge 13 that is detached for replacement from the printer 11 of the second embodiment. Then, a differential pressure regulating valve 46 is provided inside the ink cartridge 13 to switch between open and closed states on the basis of a differential pressure between an ink pressure (liquid pressure) on the ink bag 26 side in the communication portion 25, which serves as an ink flow passage, and an ink pressure (liquid pressure) on the ink delivery port 24 side and, therefore, has the function of the vacuuming second one-way valve. Thus, like reference numerals denote like components to those of the first embodiment, other than the differential pressure regulating valve 46 that serves as the vacuuming second one-way valve, and the description thereof will not be repeated.

As shown in FIG. 4, inside the ink cartridge 13 that is detached for replacement from the printer 11 of the second embodiment, an enlarged accommodation chamber 47 having a volume larger than that of the other portion of the communication portion 25 is formed in midway of the communication portion 25 that serves as an ink flow passage through which ink flows from the ink reservoir 45 side to the ink delivery port 24 side, and the differential pressure regulating valve 46 is accommodated in the accommodation chamber 47. In addition, a gap 47a is ensured and formed between the bottom wall surface of the case 23 and the lower end of the left-side wall surface that is horizontally opposite the right-side wall surface, which is the ink delivery port 24 side, in the accommodation chamber 47, and the inside of the accommodation chamber 47 communicates with the ink reservoir 45 through the gap 47a.

In addition, a diaphragm 48 is arranged in the accommodation chamber 47 so as to partition the inside of the accommodation chamber 47 into right and left spaces. Then, a pressure regulating chamber 49 is surroundingly defined in the accommodation chamber 47 by the diaphragm 48 and the right-side wall surface of the accommodation chamber 47. In addition, a cylindrical portion 50 is provided for the diaphragm 48 so as to extend through the center of the diaphragm 48. The cylindrical portion 50 extends horizontally, which is a direction in which the diaphragm 48 is displaced, inside the accommodation chamber 47. Furthermore, a coil spring 51 is arranged inside the pressure regulating chamber 49 and urges the diaphragm 48 toward the left-side wall surface of the accommodation chamber 47. Then, the diaphragm 48 is regularly displaced so that the left-side opening of the cylindrical portion 50 is brought into contact with the left-side wall surface of the accommodation chamber 47 to close the opening by the urging force of the coil spring 51, so the pressure regulating chamber 49 of the accommodation chamber 47, which is portion of the communication portion 25, is disconnected from the ink reservoir 45.

Thus, in the second embodiment, during vacuum driving of the pump 31 (FIG. 1), when the pressure regulating chamber 49 of the accommodation chamber 47 is placed in a negative pressure state inside the ink cartridge 13, the diaphragm 48 is elastically deformed (displaced) toward the right-side wall surface of the accommodation chamber 47 against the urging force of the coil spring 51, and is displaced rightward (in a direction to open the valve) so that the cylindrical portion 50 is moved away from the left-side wall surface of the accommodation chamber 47. As a result, the pressure regulating chamber 49 of the accommodation chamber 47, which is portion of the communication portion 25, communicates with the ink reservoir 45, and ink in the ink reservoir 45 is vacuumed through the opened differential pressure regulating valve 46 to the inside of the pump chamber 35 (FIG. 2) at the printer 11 side.

On the other hand, during discharge driving of the pump 31, discharge pressure of ink discharged from the pump chamber 35 is applied through the ink delivery port 24 to the pressure regulating chamber 49 to displace the diaphragm 48 in a direction to close the valve in cooperation with the urging force of the coil spring 51. As a result, the ink reservoir 45 is disconnected from the pressure regulating chamber 49, and vacuuming of ink from the ink reservoir 45 to the pump chamber 35 through the differential pressure regulating valve 46 is stopped, while ink discharged from the pump chamber 35 in accordance with discharge driving of the pump 31 is restricted from flowing back to the ink reservoir 45 side through the differential pressure regulating valve 46.

According to the printer 11 of the second embodiment, the following advantageous effects may be further obtained.

(1) In accordance with vacuum driving of the pump 31, when ink contained in the ink cartridge 13 is delivered to the outside, the diaphragm 48 of the differential pressure regulating valve 46 arranged in midway of the communication portion 25 that serves as an ink flow passage inside the ink cartridge 13 is displaced in a direction to open the valve on the basis of a negative pressure in the pressure regulating chamber 49 to thereby allow ink to pass from the upstream side to the downstream side. On the other hand, during discharge driving of the pump 31, because a negative pressure in the pressure regulating chamber 49 is eliminated, the differential pressure regulating valve 46 restricts the backflow of ink from the downstream side to the upstream side in such a manner that the diaphragm 48 is displaced in a direction to close the valve. That is, the differential pressure regulating valve 46 doubles as a vacuuming one-way valve (second one-way valve 29 in the first embodiment) during vacuum driving of the pump 31. Thus, it is not necessary to further assemble a vacuuming one-way valve, which is a component different from the differential pressure regulating valve 46. Hence, by reducing the number of components that constitute the ink cartridge 13, it is possible to improve the assembling efficiency and reduction in manufacturing cost.

### Third Embodiment

Next, a third embodiment of the invention will be described with reference to FIG. 5. Note that the third embodiment differs from the first embodiment in the following configuration. That is, no second one-way valve 29 (FIG. 1) according to the first embodiment is provided inside the ink cartridge 13 that is detached for replacement from the printer 11 of the third embodiment. Then, a pressure reducing valve 52 is provided inside the ink cartridge 13 to switch between open and closed states on the basis of a negative pressure applied from the downstream side, which is the ink delivery port 24 side, in the communication portion 25 that serves as an ink flow passage and, therefore, also has the function of the vacuuming second one-way valve. Thus, like reference numerals denote like components to those of the first embodiment, other than the pressure reducing valve 52 that serves as the vacuuming second one-way valve, and the description thereof will not be repeated.

As shown in FIG. 5, inside the ink cartridge 13 that is attached to or detached from the printer 11 of the third embodiment, an enlarged accommodation chamber 47 having a volume larger than that of the other portion of the communication portion 25 is formed in midway of the communication portion 25 that serves as an ink flow passage through which ink flows from the ink reservoir 45 side to the ink delivery port 24 side, and the pressure reducing valve 52 is accommodated in the accommodation chamber 47. In addition, a gap 47a is ensured and formed between the bottom wall surface of the case 23 and the lower end of the left-side wall surface that is horizontally opposite the right-side wall surface (right-side wall surface of the case 23), which is the ink delivery port 24 side, in the accommodation chamber 47, and the inside of the accommodation chamber 47 communicates with the ink reservoir 45 through the gap 47a.

In addition, a partition wall 54 is provided vertically in the accommodation chamber 47 so as to partition the inside of the accommodation chamber 47 into a communication chamber 45a, which communicates with the left-side ink reservoir 45, and a right-side pressure regulating chamber 53. In addition, a diaphragm 55 is arranged in the pressure regulating chamber 53 so as to partition the inside of the pressure regulating chamber 53 into right and left spaces. In addition, the atmospheric pressure is applied from the right side to the diaphragm 55 through an atmospheric communication hole 56 that is formed through the right-side wall of the case 23, which forms the right-side wall surface of the accommodation chamber 47.

As shown in FIG. 5, a valve element 57 of the pressure reducing valve 52 is fixed to a surface of the diaphragm 55 on the pressure regulating chamber 53 side. The valve element 57 includes a plate-like base portion 57a, a columnar rod portion 57b and an annular seal portion 57c. The base portion 57a is fixed to the diaphragm 55. The rod portion 57b extends from the base portion 57a so as be inserted into a communication hole 58 formed at the center portion of the partition wall 54. The seal portion 57c is formed at the distal end of the rod portion 57b. Note that the diameter of the seal portion 57c is designed to be larger than the diameter of the communication hole 58. In addition, a coil spring 59 is arranged between the base portion 57a of the valve element 57 and the partition wall 54. The valve element 57 is constantly urged by the coil spring 59, and the seal portion 57c is brought into close contact with the partition wall 54 from the communication chamber 45a side. Thus, the valve element 57 is placed in a state in which the communication hole 58 is closed (sealed) (valve closed state).

Thus, in the third embodiment, during vacuum driving of the pump 31 (FIG. 1), when the pressure regulating chamber 53 in the accommodation chamber 47 is placed in a negative pressure state in the ink cartridge 13, the diaphragm 55 is elastically deformed (displaced) toward the partition wall 53 side against the urging force of the coil spring 59 to thereby displace the valve element 57 leftward (in a direction to open the valve) so that the seal portion 57c is moved away from the partition wall 54. As a result, the pressure regulating chamber 53 in the accommodation chamber 47, which is portion of the communication portion 25, communicates with the ink reservoir 45, and ink in the ink reservoir 45 is vacuumed through the opened pressure reducing valve 52 to the inside of the pump chamber 35 (FIG. 2) at the printer 11 side.

On the other hand, during discharge driving of the pump 31, discharge pressure of ink discharged from the pump chamber 35 is applied through the ink delivery port 24 to the pressure regulating chamber 53 to displace the diaphragm 55 in a direction to close the valve in cooperation with the urging force of the coil spring 59. As a result, the ink reservoir 45 is disconnected from the pressure regulating chamber 53, and flow of ink from the ink reservoir 45 to the pump chamber 35 through the pressure reducing valve 52 is stopped, while ink discharged from the pump chamber 35 in accordance with discharge driving of the pump 31 is restricted from flowing back to the ink reservoir 45 side through the pressure reducing valve 52.

According to the printer 11 of the third embodiment, the following advantageous effects may be further obtained.

(1) In accordance with vacuum driving of the pump 31, when ink contained in the ink cartridge 13 is delivered to the outside, the diaphragm 55 of the pressure reducing valve 52 arranged in midway of the communication portion 25 that serves as an ink flow passage inside the ink cartridge 13 is displaced in a direction to open the valve on the basis of a negative pressure in the pressure regulating chamber 53 to thereby allow ink to pass from the upstream side to the downstream side. On the other hand, during discharge driving of the pump 31, because a negative pressure in the pressure regulating chamber 53 is eliminated, the pressure reducing valve 52 restricts the backflow of ink from the downstream side to the upstream side in such a manner that the diaphragm 55 is displaced in a direction to close the valve. That is, the pressure reducing valve 52 doubles as a vacuuming one-way valve (second one-way valve 29 in the first embodiment) during vacuum driving of the pump 31. Thus, it is not necessary to further assemble a vacuuming one-way valve, which is a component different from the pressure reducing valve 52. Hence, by reducing the number of components that constitute the ink cartridge 13, it is possible to improve the assembling efficiency and reduction in manufacturing cost.

Note that the above first, second and third embodiments may be modified as follows.

In the first embodiment, the liquid supply source may employ an open-type ink cartridge 13 (ink cartridges 13 of the second and third embodiments) of which the liquid container portion is an ink reservoir that is defined inside the case 23 so that ink (liquid) is storable, and the ink reservoir communicates with the atmosphere through an atmospheric relief hole formed through the case 23.

In the first embodiment, the atmospheric communication hole 30 is formed in the case 23; however, as long as a space between the case 23 and the ink bag 26 is in an atmospheric state, a communication hole is unnecessary.

In the second and third embodiments, a second one-way valve 29, which is a component different from the differential pressure regulating valve 46 or the pressure reducing valve 52, may be further arranged at a position in midway between the pressure regulating chamber 49 or 53 and the ink delivery port 24 in the communication portion 25 inside the ink cartridge 13. With this configuration, the second one-way valve 29 restricts backflow of ink into the ink cartridge 13 from the ink flow passage 16 of the ink supply device 14 through the ink delivery port 24. Thus, it is possible to suppress interference of a variation in ink pressure in the ink flow passage 16 with the characteristic of the differential pressure regulating valve 46 or pressure reducing valve 52 through the ink delivery port 24.

### Fourth Embodiment

Next, detection of ink level in the printer 11 will be described. In this case, the printer 11 has a similar configuration to that of the first embodiment and is able to detect the ink level. Thus, the detailed description of the configuration of the printer 11 is omitted, and portions related to detection of ink level will be described with reference to FIG. 2 that shows a state during vacuum driving of the pump 31.

In the printer 11, in accordance with ink consumption at the downstream side of the ink flow passage 16, such as ink ejection from the recording head 12, the ink bag 26 in the ink cartridge 13 contracts to reduce in volume so as to correspond to a reduction in ink level. Then, when the ink level in the ink bag 26 is lower than the ink level required for printing by ejecting ink from the recording head 12, it is necessary to replace the ink cartridge 13 for printing thereafter. Thus, in the fourth embodiment, the ink level in the ink bag 26 is detected as follows.

That is, when the pump 31 is driven for vacuuming in accordance with driving of the vacuum pump 40 to open the second one-way valve 29, the ink bag 26 contracts and, therefore, ink of an amount corresponding to the amount of reduction in volume is vacuumed from the ink bag 26 side into the pump chamber 35. In addition, in accordance with vacuum driving of the pump 31, the pressure in the negative pressure chamber 43 reduces. Thus, the pressure detector 41 connected through the air flow passage 39 to the negative pressure chamber 43 initiates detection of the pressure. Then, as the detected pressure is output to the controller 44, the controller 44 measures a duration during which the detected pressure reaches a predetermine value (that is, a pressure at the time when vacuum driving of the pump 31 is complete normally), and determines whether the measured duration exceeds a determination threshold that is prestored as a duration corresponding to the case in which the diaphragm 33 is displaced to a position at which the volume of the negative pressure chamber 43 is minimal. After that, on the basis of the determination result, the ink level in the ink bag 26 is detected. In this case, the controller 44 serves as a liquid level detector for detecting the ink level, and the negative pressure chamber 43 serves as a working fluid introducing chamber that introduces air as working fluid.

Here, when the ink level in the ink bag 26 sufficiently remains for ejecting ink from the recording head 12 during printing, the diaphragm 33 is displaced in accordance with vacuum driving of the pump 31 to a position that minimizes the volume of the negative pressure chamber 43 as a displacement member. Thus, when the controller 44 determines that the measured duration falls within the determination threshold on the basis of a detected signal of the pressure detector 41, the controller 44 detects that the ink level in the ink bag 26 is not in an ink end state.

On the other hand, in a case where the ink level in the ink bag 26 is extremely low, that is, in an ink near end state, when a small amount of ink remaining in the ink bag 26 is completely vacuumed from the ink bag 26 side into the pump chamber 35 in accordance with vacuum driving of the pump 31, the ink level becomes zero and then the ink bag 26 cannot contract to reduce the volume any more. Then, because ink that flows from the ink bag 26 side into the pump chamber 35 ends by a small amount, the diaphragm 33 of the pump 31 cannot be displaced toward the negative pressure chamber 43 side any more. Thus, the volume of the negative pressure chamber 43 at that time remains larger than the minimum volume of the negative pressure chamber 43 during normal time and does not vary.

Then, the pressure detector 41 detects a predetermined pressure at the time when the vacuum pump 40 further vacuums air by the volume differential and then outputs the detected signal to the controller 44. Thereafter, when the controller 44 determines that the measured duration based on the detected signal is larger than the determination threshold, the controller 44 detects that the ink level in the ink bag 26 is in an ink end state.

Then, as described above, when the controller 44 detects that the ink level in the ink bag 26 is in an ink end state, the controller 44 outputs a control signal for notifying the necessity of replacement of the ink cartridge 13 that accommodates the ink-end ink bag 26 and displays the message of that notification on a display panel (not shown). In addition, even when the pump 31 is further driven for vacuuming, ink cannot be vacuumed from the inside of the ink bag 26. Thus, in order to stop unnecessary vacuum driving of the pump 31, driving of the vacuum pump 40 is stopped.

According to the fourth embodiment, the following advantageous effects may be obtained.

(1) In the fourth embodiment, during vacuum driving by which the pump 31 displaces the diaphragm 33 in a direction to increase the volume of the pump chamber 35 to thereby vacuum ink from the upstream side, which is the ink cartridge 13 side, into the pump chamber 35, when the ink level in the ink bag 26 is zero, the amount of displacement of the diaphragm 33 differs from the amount of displacement when the ink level in the ink bag 26 is sufficient. This results in a varied duration in which the volume of the negative pressure chamber 43 partitioned from the pump chamber 35 by the diaphragm 33 varies and then the pumping operation causes the pressure in the negative pressure chamber 43 to reach a predetermined pressure. Therefore, the controller 44 is able to accurately detect an ink end state on the basis of a variation in pressure in the negative pressure chamber 43 during vacuum driving of the pump 31 without using calculation that is likely to erroneously detect the ink level in the ink bag 26. Hence, when ink is supplied from the upstream side, which is the ink cartridge 13 side, toward the downstream side, it is possible to supply ink in the ink bag 26 to the end without waste.

(2) In addition, the controller 44 determines that the ink level in the ink bag 26 is in an ink end state when a duration, in which a pressure of air in the negative pressure chamber 43 after initiation of vacuum driving of the pump 31, reaches a predetermined pressure is longer than a predetermined duration when the ink level in the ink bag 26 is sufficient. That is, when the ink level in the closed-space ink bag 26 in the ink cartridge 13 is completely vacuumed by vacuum driving of the pump 31, ink cannot be vacuumed from the inside of the ink bag 26 any more, so the amount of displacement of the diaphragm 33 is smaller than the amount of displacement when the ink level in the ink bag 26 is sufficient. Thus, because the volume of the negative pressure chamber 43 remains large and unchanged during vacuum driving of the pump 31, a duration until the pressure in the negative pressure chamber 43 reaches a predetermined pressure by pumping operation elongates. Hence, by detecting that a duration until a pressure of air in the negative pressure chamber 43 after initiation of vacuuming of the pump 31 reaches a predetermined value is longer than a duration when the ink level in the ink bag 26 is sufficient, the controller 44 is able to reliably detect an ink end state.

(3) In the fourth embodiment, air is used as working fluid for driving the pump 31. Thus, different from the case in which liquid, such as silicon oil, is, for example, used as working fluid, it is possible to improve the response of pumping because of low viscosity. In addition, when a working fluid supply passage is formed of a tube, the weight of the tube is light.

(4) In the fourth embodiment, the ink cartridge 13 accommodates the flexible ink bag 26 inside, and the ink bag 26 contains ink inside (closed-space liquid container portion). Thus, it is possible to obtain the liquid supply source (ink bag 26) in which the closed-space liquid container portion that contains liquid (ink) varies in volume in accordance with the liquid (ink) level with a simple configuration.

(5) In the fourth embodiment, the ink supply device 14 stops driving of the vacuum pump 40 when the controller 44 detects that the ink level in the ink bag 26 is in an ink end state. Thus, when, in an ink end state, ink cannot be vacuumed even when vacuum driving of the pump 31 is continued, it is possible to suppress an excessive driving load on the vacuum pump 40 by stopping unnecessary driving of the vacuum pump 40 any more.

Note that the fourth embodiment may be modified as follows.

In the fourth embodiment, the liquid supply source having the closed-space liquid container portion inside is not limited to the ink bag 26 as a flexible liquid container bag. For example, an ink container chamber may be formed as a liquid container portion that is a closed space and that varies in volume in such a manner that the ink container chamber is formed inside the ink cartridge 13, and a sealing member for sealing ink is arranged to float on the liquid surface of ink in the ink container chamber. In this case, the ink cartridge 13 is a liquid supply source. In short, it is only necessary that a closed-space liquid container portion that varies in volume in accordance with the liquid level is provided.

In the fourth embodiment, air is used as working fluid by which the inside of the ink cartridge 13 is pressurized or decompressed; instead, liquid, such as silicon oil, may be used as working fluid.

### Fifth Embodiment

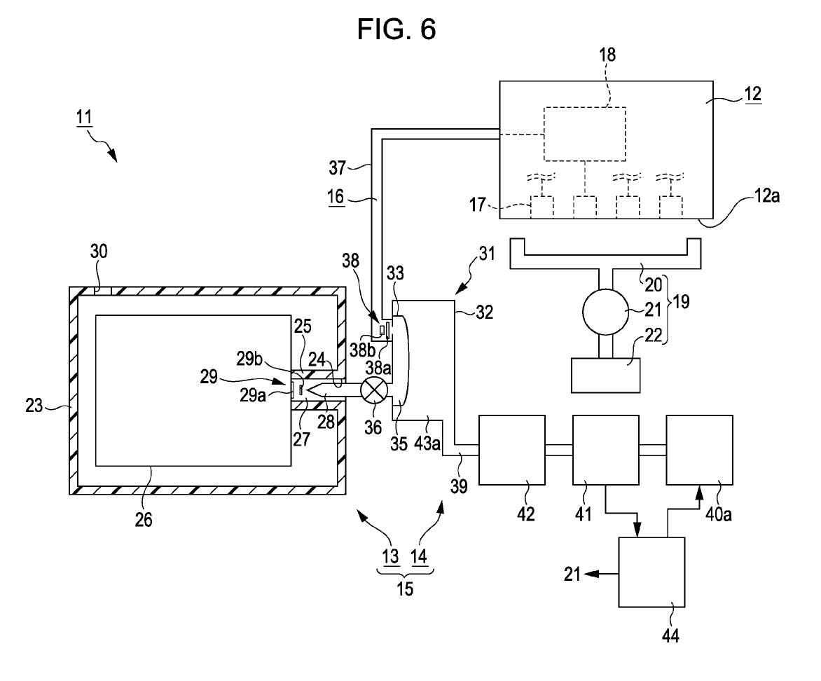

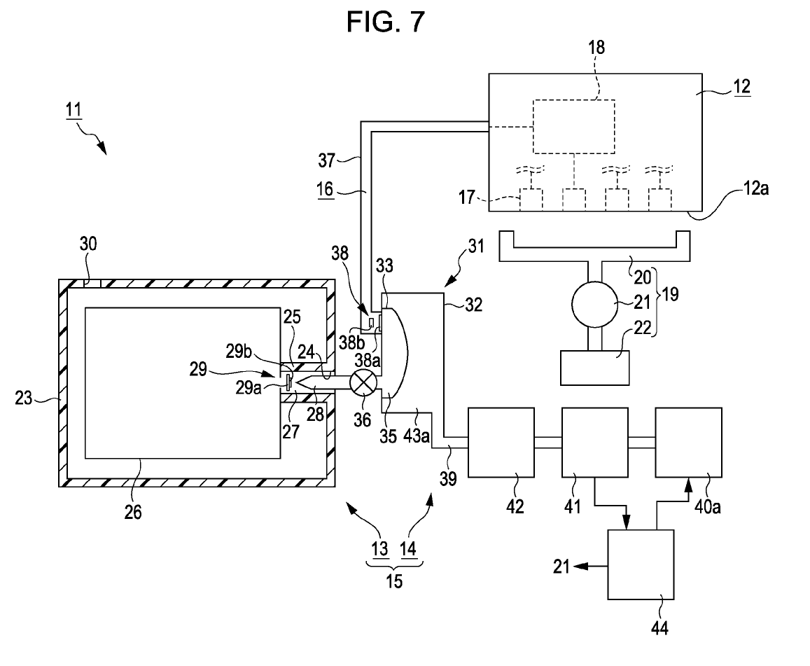

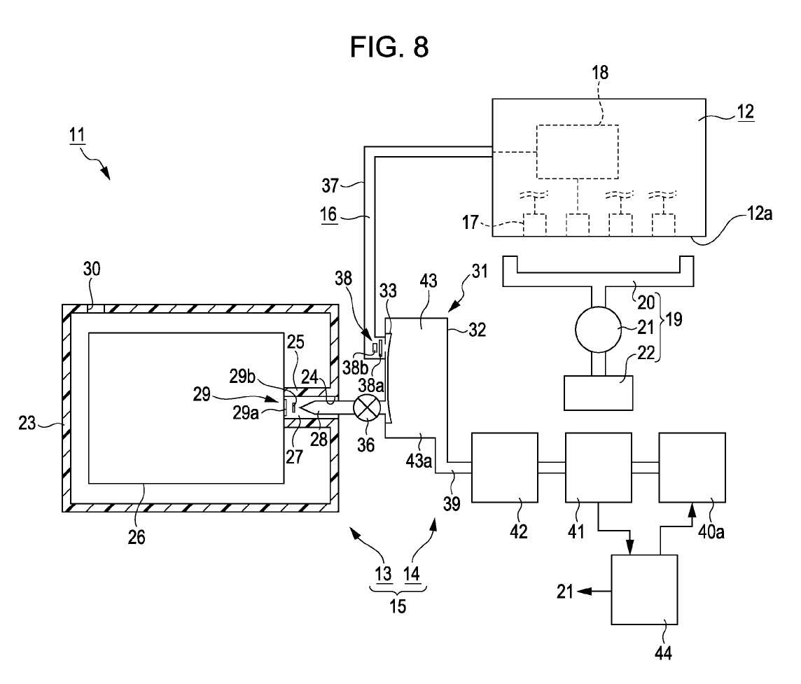

Next, in the printer 11, the configuration by which pressure applied to ink supplied to the recording head 12 may be variable will be described. As shown in FIG. 6, FIG. 7 and FIG. 8, the printer 11 according to the fifth embodiment differs from that of the first embodiment in that the pump 31 of the ink supply device 14 does not include a coil spring, the vacuum pump 40 of the first embodiment is a pump device 40a that is able to pressurize and decompress, and the negative pressure chamber 43 of the first embodiment corresponds to a working fluid introducing chamber 43a.

In this case, the pump device 40a is connected through the air flow passage 39 to a space that serves as a volume-variable working fluid introducing chamber surroundingly defined by the diaphragm 33 and the right-side wall surface of the pump case 32. Then, the pump device 40a is driven for pressurization to generate a positive pressure, and also generates a positive pressure in the working fluid introducing chamber 43a that is connected through the air flow passage 39 to the pump device 40a. Similarly, the pump device 40a is driven for vacuuming to generate a negative pressure, and similarly generates a negative pressure in the working fluid introducing chamber 43a that is connected through the air flow passage 39 to the pump device 40a. In addition, the pressure detector 41 detects a pressure in the working fluid introducing chamber 43a connected through the air flow passage 39, and outputs the detected pressure to the controller 44, which serves as a control device.

The operation of the thus configured printer 11 will be described particularly focusing on the operation of the ink supply device 14. First, it is assumed that FIG. 6 shows a state immediately after replacement to a new ink cartridge 13, and the atmospheric relief valve (atmospheric relief device) 42 is closed.

Then, in the state shown in FIG. 1, when the ink supply device 14 supplies ink from the ink cartridge 13 to the recording head 12 side, first, the pump device 40a is driven for vacuuming in order to drive the pump 31. After that, the pump device 40a generates a negative pressure, and the working fluid introducing chamber 43a of the pump 31, connected to the pump device 40a through the air flow passage 39, is placed in a negative pressure state. Thus, the diaphragm (displacement member) 33 is elastically deformed (displaced) toward the working fluid introducing chamber 43a to reduce the volume of the working fluid introducing chamber 43a. Then, in accordance with the reduction in volume of the working fluid introducing chamber 43a, the pump chamber 35 of the pump 31, which is partitioned from the working fluid introducing chamber 43a through the diaphragm 33, increases in volume conversely (see FIG. 7).

That is, the pump 31 displaces the diaphragm 33 in a direction to increase the volume of the pump chamber 35 to perform vacuum driving. Thus, the inside of the pump chamber 35 is placed in a negative pressure state, and the negative pressure is applied from the downstream side to the valve element 29a that constitutes the vacuuming second one-way valve 29 through the ink flow passage 16. Then, on the basis of a differential pressure with respect to an ink pressure applied from the ink bag 26 side, which is the upstream side of the vacuuming second one-way valve 29, the valve element 29a is displaced rightward (in a direction to open the valve). As a result, the inside of the ink bag 26 communicates with the pump chamber 35 and, therefore, ink contained in the ink bag 26 is vacuumed into the pump chamber 35 through the ink supply needle 28.

On the other hand, when the pump 31 is driven for vacuuming, the negative pressure in the pump chamber 35 is also applied to the upstream side of the discharging first one-way valve 38. Here, the inside of the pump chamber 35 is lower in pressure than the inside of the ink supply tube 37, which is the downstream side of the discharging first one-way valve 38, and the valve element 38a is displaced rightward (in a direction to open the valve) on the basis of a differential pressure between the inside of the pump chamber 35 and the inside of the ink supply tube 37. As a result, the inside of the pump chamber 35 is disconnected from the inside of the ink supply tube 37.

Thereafter, in the state shown in FIG. 7, in order to determine whether the pump 31 initiates discharge driving, the pressure detector (detecting device) 41 detects a pressure accumulated in the working fluid introducing chamber 43a by vacuum driving of the pump device 40a. Then, when the detected pressure reaches a predetermined threshold, the controller 44 switches driving of the pump device 40a into pressurization to initiate discharge driving of the pump 31. Then, the diaphragm 33 of the pump 31 is elastically deformed (displaced) toward the pump chamber 35 to increase the volume of the working fluid introducing chamber 43a (see FIG. 8). With the increase in volume of the working fluid introducing chamber 43a, the pump chamber 35 of the pump 31, which is partitioned from the working fluid introducing chamber 43a by the diaphragm 33, reduces in volume conversely. Note that pressurization driving of the pump device 40a is stopped at the time when the pressure in the working fluid introducing chamber 43a reaches a predetermined pressure, which is set as an upper limit value of a discharge pressure of the pump in advance.

Then, at this time, the pump 31 displaces the diaphragm 33 in a direction to reduce the volume of the pump chamber 35 for discharge driving. Thus, ink is discharged from the inside of the pump chamber 35, and the discharge pressure is applied from the downstream side to the valve element 29a that constitutes the vacuuming second one-way valve 29 through the ink flow passage 16 on the upstream side with respect to the pump chamber 35 to thereby displace the valve element 29a in a direction to close the valve. As a result, the inside of the ink bag 26 is disconnected from the ink flow passage 16 due to the valve closing operation of the vacuuming second one-way valve 29, and vacuuming of ink from the ink cartridge 13 to the pump chamber 35 through the vacuuming second one-way valve 29 is stopped, while ink discharged from the pump chamber 35 in accordance with driving of the pump 31 for discharging is restricted from flowing back through the vacuuming second one-way valve 29 to the ink cartridge 13 side.

On the other hand, during discharge driving of the pump 31, the pressure of ink discharged from the pump chamber 35 is applied to the upstream side of the discharging first one-way valve 38. Thus, the discharge pressure of the pump 31 causes the closed valve element 38a to perform a valve opening operation, and, therefore, the pump chamber 35 communicates with the inside of the ink supply tube 37 through the discharging first one-way valve 38. As a result, pressurized ink is supplied from the pump chamber 35 through the ink supply tube 37 to the valve unit 18.

Then, after that, the discharge pressure of ink discharged from the pump chamber 35 by being pressurized by the diaphragm 33 is uniformly applied to the flow passage regions downstream of the vacuuming second one-way valve 29 in the ink flow passage 16, and this state is maintained. After that, as ink is ejected from the recording head 12 toward the target, ink of an amount corresponding to the amount of ink consumed by the ink ejection is supplied from the inside of the ink flow passage 16 through the valve unit 18 to the recording head 12 side. Thus, with the ink consumption at the downstream side (recording head 12 side) pressurized ink of an amount corresponding to the amount consumed is supplied to the downstream side, which is the recording head 12 side, on the basis of the pressing force (positive pressure) of the diaphragm 33 that is urged by the air pressure accumulated in the working fluid introducing chamber 43a in a direction to reduce the volume of the pump chamber 35.

As a result, the volume in the pump chamber 35 gradually reduces, and finally the diaphragm 33 is displaced to near a position at which the diaphragm 33 contacts the left-side wall surface of the pump case 32 so that the volume of the pump chamber 35 is minimal (see FIG. 8). At this time, with the reduction in volume of the pump chamber 35, the working fluid introducing chamber 43a, which is partitioned from the pump chamber 35 by the diaphragm 33, increases in volume conversely. Then, with the increase in volume, the pressure in the working fluid introducing chamber 43a gradually reduces and finally becomes a pressure value lower than a predetermined pressure as a lower limit value of the discharge pressure of the pump 31.

Then, the controller 44 drives the pump device 40a for vacuuming again, and then the pump device 40a generates a negative pressure to place the working fluid introducing chamber 43a in a negative pressure state. Thus, the diaphragm 33 is elastically deformed (displaced) toward the working fluid introducing chamber 43a. That is, the pump 31 initiates vacuum driving again. As a result, when the diaphragm 33 is displaced in a direction to increase the volume of the pump chamber 35, the inside of the pump chamber 35 is placed in a negative pressure state, so the valve element 29a that constitutes the vacuuming second one-way valve 29 is moved in a direction to open the valve by the action of the negative pressure. Thus, the inside of the ink bag 26 communicates with the ink flow passage 16 through the vacuuming second one-way valve 29, and ink is vacuumed from the inside of the ink bag 26 to the inside of the pump chamber 35 again. After that, the pump 31 is driven for discharging as in the above manner, and ink is pressurized and supplied from the inside of the pump chamber 35 through the ink supply tube 37 to the recording head 12.

Incidentally, a predetermined pressure value, which is set as a lower limit value of the discharge pressure of the pump 31, needs to be changed depending on the specifications of the printer 11. For example, when the printer 11 has the specifications that the number of nozzles of the recording head is increased or the discharge interval (how often ink is discharged for a certain period of time) is reduced in order to increase print speed, the amount of maximum ink discharge each time the recording head (liquid consuming portion) 12 ejects ink (the amount of maximum liquid consumption per unit liquid consumption) increases. In addition, when the printer 11 is able to handle large-size printing, the length of the ink flow passage 16 increases. When a special ink is used, the viscosity of ink is different and, therefore, the resistance of the flow passage varies. Moreover, by taking into consideration usability, when the position of an ink cartridge mounting portion is changed, a height difference (head difference) varies. Then, when these factors vary, the discharge pressure when ink is discharged in accordance with discharge driving of the pump 31 (that is, applied pressure when ink is pressurized and supplied) also needs to be changed. Thus, in the fifth embodiment, the discharge pressure of the pump 31 is adjusted as in the following manner.

That is, when the maximum ink discharge amount increases in accordance with a change of the specifications of the recording head 12, even when the specifications of the ink flow passage 16 is the same, a pressure loss that occurs in the flow passage regions downstream of the pump chamber 35 due to an increase in flow rate increases. Thus, in accordance with this, it is necessary to increase a predetermined pressure value that is set as a lower limit value of the discharge pressure of the pump 31. Then, when the pump 31 is installed on the printer 11 having such specifications, a predetermined pressure value that is set as a lower limit value of the discharge pressure of the pump 31 in the controller 44 is changed to thereby make it possible to simply and appropriately pressurize and supply ink.

In addition, when the flow passage resistance of the ink flow passage 16 increases in accordance with a change of the specifications of the ink flow passage 16, a pressure loss via the inner wall surface of the ink flow passage 16 against the flow pressure of ink that flows through the ink flow passage 16 increases. In this case as well, in accordance with this, it is necessary to increase a predetermined pressure value that is set as a lower limit value of the discharge pressure of the pump 31. When the pump 31 is installed on the printer 11 having such specifications, only a predetermined pressure value that is set as a lower limit value of the discharge pressure of the pump 31 in the controller 44 is changed to thereby make it possible to simply and appropriately pressurize and supply ink. Note that when a pressure loss against the flow pressure of ink that flows through the ink flow passage 16 increases in accordance with an increase in ink viscosity as well, a similar measure is taken.

According to the fifth embodiment, the following advantageous effects may be obtained.

(1) In the fifth embodiment, during discharge driving by which the pump 31 displaces the diaphragm 33 in a direction to reduce the volume of the pump chamber 35 to pressurize and supply ink, contained in the pump chamber 35, to the downstream side, the pressure of air in the working fluid introducing chamber 43a partitioned from the pump chamber 35 by the diaphragm 33 is controlled to control pressing force (positive pressure) of the diaphragm 33 toward the pump chamber 35. Then, in accordance with the control of the pressing force (positive pressure), the discharge pressure of ink discharged from the pump chamber 35 is controlled in order to pressurize and supply ink toward the recording head 12. Thus, the applied pressure when ink is pressurized and supplied from the upstream side, which is the ink cartridge 13, toward the downstream-side recording head 12 on the basis of pump driving may be simply adjusted as needed.

(2) In the fifth embodiment, during discharge driving of the pump 31, in accordance with supply of ink from the pump chamber 35 to the downstream side, the diaphragm 33 is displaced in a direction to reduce the volume of the pump chamber 35, and the volume of the working fluid introducing chamber 43a partitioned from the pump chamber 35 by the diaphragm 33 increases. Then, in accordance with the increase in volume of the working fluid introducing chamber 43a, the pressure of air in the working fluid introducing chamber 43a gradually decreases, and the discharge pressure of ink supplied from the pump chamber 35 also decreases at the same time. Thus, when a decrease in pressure of air in the working fluid introducing chamber 43a is detected, the driving state of the pump 31 is controlled in order to increase the discharge pressure of ink supplied from the pump chamber 35. That is, ink is vacuumed from the ink cartridge 13 side into the pump chamber 35 by switching driving of the pump 31 into vacuuming once, and then the pump 31 is driven for discharging so that the pressure of air in the working fluid introducing chamber 43a falls within a predetermined range that is set as a discharge pressure of the pump 31. Thus, it is possible to control the driving state of the pump 31 so that the discharge pressure of ink pressurized and supplied to the downstream side, at which ink is consumed, is constantly a value appropriate to the specifications of the ink supply device 14.

(3) In the fifth embodiment, when the factors, such as the maximum ink discharge amount of the recording head 12, the flow passage resistance of the ink flow passage 16 of the ink supply device 14 or the viscosity of ink, vary in association with the specifications of the printer 11, in accordance with the variation, the condition of the pressure of air in the working fluid introducing chamber 43a during discharge driving of the pump 31 is changed. Then, by changing the condition of the pressure of air, pressing force by which air in the working fluid introducing chamber 43a presses the diaphragm 33 toward the pump chamber 35 varies and, as a result, the discharge pressure of the pump 31 varies. Thus, it is possible to appropriately change the pressure applied to ink supplied from the pump 31 to the downstream side in accordance with the specifications of the factors in the ink supply device 14.

(4) In the fifth embodiment, air is used as working fluid for driving the pump 31. Thus, different from the case in which liquid, such as silicon oil, is, for example, used as working fluid, it is possible to improve the response of pump driving because of a low viscosity. In addition, when a working fluid supply passage is formed of a tube, the weight of the tube is light.

(5) In the fifth embodiment, the ink supply device 14 includes the atmospheric relief valve 42 that applies the working fluid introducing chamber 43a, by which the inside of the pump chamber 35 is pressurized or decompressed, with atmospheric pressure. Thus, by opening the inside of the working fluid introducing chamber 43a through the atmospheric relief valve 42 to the atmosphere, it is possible to release the pressurized state or decompressed state in the ink flow passage 16 connected to the pump chamber 35 where necessary.

Note that the fifth embodiment may be modified as follows.

In the fifth embodiment, an urging member (coil spring, or the like) that urges the diaphragm 33 in a direction to increase the volume of the pump chamber 35 may be provided inside the working fluid introducing chamber 43a of the pump 31. In this case, because ink may be vacuumed on the basis of the urging force of the urging member from the ink cartridge 13 side into the pump chamber 35, the pump device 40a need not have the vacuum driving function. Thus, the pump device 40a may employ a pump device that has only the pressure driving function.

In the fifth embodiment, the controller 44 may be configured to not only control the applied pressure in the working fluid introducing chamber 43a during discharge driving of the pump 31 but also control the vacuum pressure in the working fluid introducing chamber 43a during vacuum driving of the pump 31. In this case, it is possible to simply adjust the vacuum pressure when ink is vacuumed from the ink cartridge 13 side into the pump chamber 35 to a value appropriate to the design of the ink supply device 14.

In the fifth embodiment, switching of the pump 31 between vacuum driving and discharge driving may be performed not on the basis of the pressure in the working fluid introducing chamber 43a, detected by the pressure detector 41, but on the basis of a duration since the pump device 40a is switched into vacuum driving or pressure driving.

In the fifth embodiment, air is used as working fluid that is introduced into the working fluid introducing chamber 43a; instead, liquid, such as silicon oil, may be used as working fluid.

### Sixth Embodiment

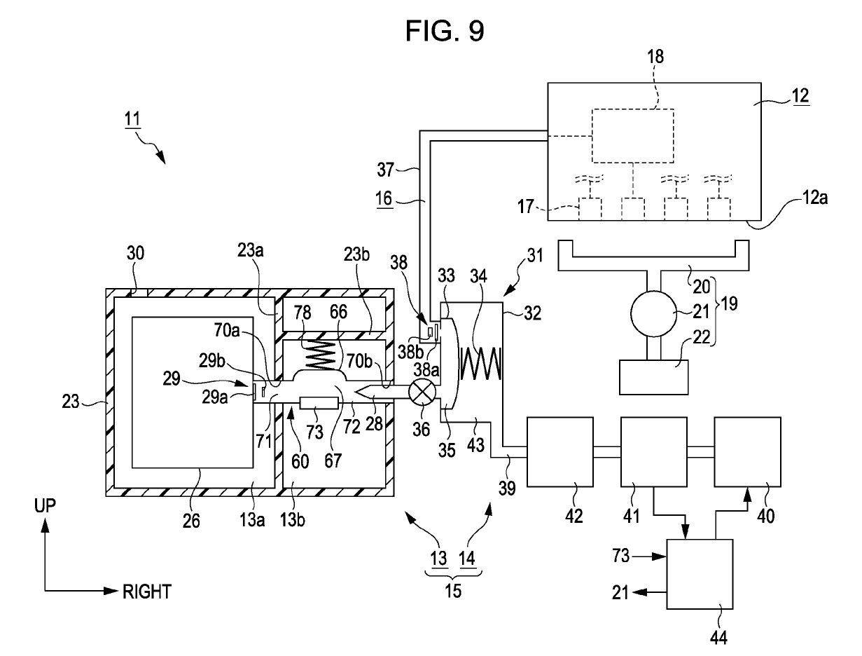

Next, another configuration of detection of ink level in the printer 11 will be described with reference to FIG. 9 to FIG. 13B. In this case, the printer 11 differs from that of the first embodiment in the configuration of the ink cartridge 13. Thus, the detailed description other than the ink cartridge 13 is omitted.

As shown in FIG. 9, the ink cartridge 13 includes a case 23 made of synthetic resin material and formed into substantially a box shape. The inside of the case 23 is partitioned into two left and right spaces by a partition wall 23a, and, as shown in FIG. 9, the left-side space is an ink container chamber 13a, and the right-side space is a sensor accommodation chamber 13b.

Of these, the ink container chamber 13a accommodates the ink bag 26 that is formed of a flexible liquid container bag and that seals (contains) ink inside the closed-space liquid container portion. Then, the atmospheric communication hole 30 is formed through the upper wall of the case 23 above the ink container chamber 13a so as to communicate the inside of the ink container chamber 13a with the atmosphere. Thus, atmospheric pressure is applied on the outer surface of the ink bag 26 that contains ink.

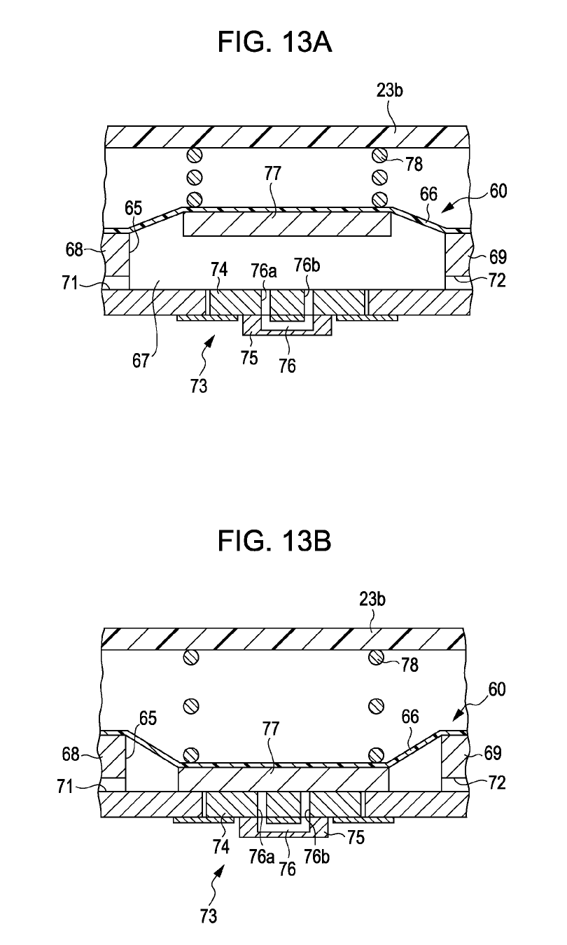

On the other hand, as shown in FIG. 9, FIG. 13A and FIG. 13B, the sensor accommodation chamber 13b accommodates substantially a disk-shaped detecting element 60 having a thickness vertically in FIG. 9. As shown in FIG. 13A and FIG. 13B, the detecting element 60 has a recessed portion 65 that opens upward, and a flexible film 66, which serves as a displacement member in this case, is fixedly connected on the upper end of the recessed portion 65 so as to seal the opening of the recessed portion 65 with some deflection. Then, the recessed portion 65 and flexible film 66 of the detecting element 60 surroundingly define a volume-variable ink reservoir portion 67, which serves as a liquid reservoir portion.

An inflow-side protrusion 68 is provided at the left end of the detecting element 60, and an outflow-side protrusion 69 is provided at the right end of the detecting element 60. In addition, the partition wall 23a that partitions the ink container chamber 13a from the sensor accommodation chamber 13b has a through-hole 70a, and a through-hole 70b is formed in the right wall of the case 23 at a position horizontally facing the through-hole 70a.

Then, the inflow-side protrusion 68 and the outflow-side protrusion 69 are respectively fitted into the left and right through-holes 70a and 70b, so the detecting element 60 is supported on the case 23. In addition, the inflow-side protrusion 68 of the detecting element 60 has an ink inlet port 71 that is formed therethrough so as to communicate with the inside of the ink reservoir portion 67, and the outflow-side protrusion 69 has an ink outlet port 72, which serves as a liquid delivery portion in this case, that is formed therethrough so as to communicate with the inside of the ink reservoir portion 67.

Note that when the inflow-side protrusion 68 is fitted into the through-hole 70a, the distal end of the inflow-side protrusion 68 protrudes from the through-hole 70a into the ink container chamber 13a. Thus, when the ink bag 26 is connected to the inflow-side protrusion 68 that protrudes into the ink container chamber 13a, ink in the ink bag 26 flows through the ink inlet port 71 of the inflow-side protrusion 68 into the ink reservoir portion 67. Moreover, the inflow-side protrusion 68 includes the second one-way valve 29 that only allows ink to pass from the upstream side, which is the ink bag 26 side, to the downstream side, which is the ink reservoir portion 67 side. The second one-way valve 29 includes a valve element 29a and a retainer portion 29b. The valve element 29a reciprocally and horizontally moves between an open valve position and a closed valve position in accordance with a variation in ink pressure and flow of ink. The retainer portion 29b retains the valve element 29a that moves in a direction to open the valve.

In addition, an ink level detecting portion 73, which serves as a liquid level detector in this case, is provided at the lower portion of the detecting element 60. The ink level detecting portion 73 has a bottom plate 74 at a position which corresponds to the bottom of the recessed portion 65, and a piezoelectric sensor 75, which serves as a piezoelectric element, is provided below the bottom plate 74. Then, an ink guide passage 76, which serves as a recess, is provided so that the ink guide passage 76 extends through the bottom plate 74 and the piezoelectric sensor 75 and two opening portions 76a and 76b open at the upper surface of the bottom plate 74. The piezoelectric sensor 75 applies vibration to a detection space defined inside the ink guide passage 76 in the ink reservoir portion 67, detects the state of free oscillation in accordance with the vibration and then outputs the detected result as a detected signal. Then, the detected result is transmitted to the controller 44, which serves as a detecting portion and a calculation portion.

Then, a closing member 77 is fixedly connected to the lower surface side of the flexible film 66 at a position facing the bottom plate 74. On the other hand, a retaining wall 23b is provided above the flexible film 66 at a position between the upper wall of the case 23 and the flexible film 66 so as to be parallel to the upper wall. Then, a coil spring 78 is held between the upper surface of the flexible film 66 and the retaining wall 23b so as to elastically urge the closing member 77 and the flexible film 66 in a direction to reduce the volume of the ink reservoir portion 67.

Note that when the closing member 77 contacts the bottom plate 74 by the urging force of the coil spring 78 as well, the ink inlet port 71 and the ink outlet port 72 are in communication with each other via the surroundings of the closing member 77 (see FIG. 13B).

Then, when ink contained in the ink reservoir portion 67 is increased, the closing member 77, as shown in FIG. 13A, is displaced in a direction to increase the volume of the ink reservoir portion 67 against the urging force of the coil spring 78. On the other hand, when ink contained in the ink reservoir portion 67 is reduced, as shown in FIG. 13B, the closing member 77 closely contacts the bottom plate 74 from above by the urging force of the coil spring 78. That is, the volume of the ink reservoir portion 67 is variable in such a manner that the closing member 77 and the flexible film 66 move in accordance with the amount of ink contained.

Note that when such an ink cartridge 13 is connected to the ink supply device 14, the ink supply needle 28, which protrudes from the ink supply device 14 to form the upstream end of the ink flow passage 16, is inserted into the detecting element 60 through the ink outlet port 72. At this time, the periphery of the ink supply needle 28 is sealed by a seal member (not shown) in the ink outlet port 72.

Here, as the vacuum pump 40 is driven, the negative pressure chamber 43 is reduced in pressure to increase the volume of the pump chamber 35, so the pump chamber 35 is placed in a negative pressure state. Then, the second one-way valve 29 is opened, and ink contained in the ink bag 26 is vacuumed through the ink inlet port 71, the ink reservoir portion 67, the ink outlet port 72 and the ink supply needle 28 to the pump chamber 35. Then, as the atmospheric relief valve 42 is opened, the coil spring 34 pressurizes ink in the pump chamber 35 and supplies the ink through the ink supply tube 37 to the recording head 12, and portion of the pressurized ink flows into the ink reservoir portion 67 through the ink supply needle 28 and the ink outlet port 72 to displace the flexible film 66 and the closing member 77 upward.

That is, the pump 31 is driven for vacuuming during driving of the vacuum pump 40, while being driven for discharging during opening of the atmospheric relief valve 42. However, even when the pump 31 is driven for vacuuming and, therefore, the pump chamber 35 is placed in a negative pressure state, when the amount of ink contained in the ink bag 26 reduces, the amount of ink vacuumed reduces. Thus, the amount of ink that flows from the pump chamber 35 into the ink reservoir portion 67 reduces, and an increase in volume of the ink reservoir portion 67 is suppressed. Then, in the sixth embodiment, an ink end state in which ink in the ink bag 26 is out is set to a state in which the closing member 77 contacts the bottom plate 74 because the volume of the ink reservoir portion 67 does not increase during discharge driving and, therefore, the ink guide passage 76 is closed.

Next, an ink end determination method for determining a state in which the amount of ink in the ink bag 26 is zero will be described. As shown in FIG. 13B, when the closing member 77 contacts the bottom plate 74, the opening portions 76a and 76b of the ink guide passage 76 are closed by the closing member 77. On the other hand, as shown in FIG. 13A, when the closing member 77 is located away from the bottom plate 74, the ink guide passage 76 is open to the ink reservoir portion 67 through the opening portions 76a and 76b.

The inside of the ink guide passage 76 is filled with ink, and the piezoelectric sensor 75 detects different states of free oscillation when the ink guide passage 76 is closed by the closing member 77 and when the ink reservoir portion 67 is open. That is, the ink level detecting portion 73 executes a detecting operation to detect whether the closing member 77 contacts the bottom plate 74 and the volume of the ink reservoir portion 67 is smaller than or equal to a predetermined amount. Thus, the ink level detecting portion 73 detects the amount of ink in the ink reservoir portion 67, and outputs a detected result for determining the amount of ink in the ink bag 26.

In addition, the piezoelectric sensor 75 is communicable with the controller 44 provided for the printer 11. Then, the controller 44, which receives the detected result, detects the amplitude or frequency of residual oscillation waveform of a counter electromotive force of the free oscillation detected by the piezoelectric sensor 75, and then calculates the ink level in the ink bag 26. Note that communication between the piezoelectric sensor 75 and the controller 44 may be executed in a noncontact manner by providing an antenna, or the like, to each of the piezoelectric sensor 75 and the controller 44, or the piezoelectric sensor 75 may be electrically connected to the controller 44 when the ink cartridge 13 is attached.

Then, next, the operation of the thus configured printer 11 will be described particularly focusing on the operation of the ink supply system 15. First, it is assumed that FIG. 9 shows a state in which ink is sufficient in the ink flow passage 16 and the pump 31 is driven for discharging to pressurize and supply ink to the downstream side.

That is, the atmospheric relief valve 42 is opened, and the diaphragm 33 is urged by the coil spring 34 in a direction to reduce the volume of the pump chamber 35 to thereby apply pressure to ink in the pump chamber 35. Thus, the first one-way valve 38 displaces the valve element 38a leftward (in a direction to open the valve) on the basis of a differential pressure between the inside of the pump chamber 35 and the inside of the ink supply tube 37. Then, the pump chamber 35 communicates with the ink supply tube 37 through the first one-way valve 38, and the pressurized ink is supplied from the pump chamber 35 through the ink supply tube 37 to the valve unit 18.

On the other hand, on the upstream of the pump 31, ink applied with pressure is applied from the downstream side to the valve element 29a that constitutes the second one-way valve 29 through the flow passage opening/closing valve 36, the ink outlet port 72, the ink reservoir portion 67, and the ink inlet port 71, the second one-way valve 29 is closed. As a result, ink that flows from the downstream side into the ink cartridge 13 is blocked by the second one-way valve 29, and increases the volume of the ink reservoir portion 67 so as to resist against the urging force of the coil spring 78 by the applied pressure of the coil spring 34 of the pump 31.

That is, the discharge pressure of ink discharged from the pump chamber 35 by being pressurized by the diaphragm 33 is uniformly applied downstream of the second one-way valve 29, and this state is maintained. Then, as ink is ejected from the recording head 12 toward the target, ink of an amount corresponding to the amount of ink consumed by the ink ejection is supplied from the inside of the ink flow passage 16 to the recording head 12 side.

Note that the inside of the pump chamber 35 is pressurized by the urging force of the coil spring 34, so it is possible to maintain the pressurized state without providing an additional device for pressurizing the inside of the pump chamber 35. In addition, when a device that has both the function of a pressure generating device and the function of a negative pressure generating device is employed as a driving source for the pump 31, a complex control configuration for maintaining the pressurized state inside the pump chamber 35 is necessary; however, when the coil spring 34 is employed as a driving source for the pump 31, it is possible to simply maintain the pressurized state inside the pump chamber 35.

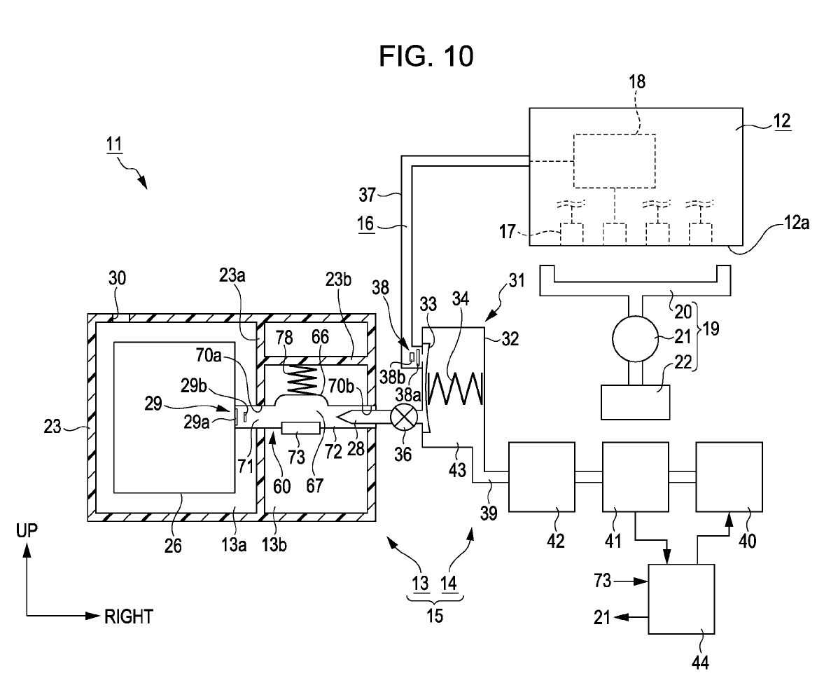

Then, ink is gradually consumed by ejecting ink from the recording head 12, the volume of the pump chamber 35 gradually reduces, and finally the diaphragm 33 is displaced to near a position at which the diaphragm 33 contacts the left-side wall surface of the pump case 32 so that the volume of the pump chamber 35 is minimal (see FIG. 10). At this time, because the urging force of the coil spring 78 that urges in a direction to reduce the volume of the ink reservoir portion 67 is weaker than the urging force of the coil spring 34 of the pump 31, the volume of the ink reservoir portion 67 is increased.

Note that the urging force of the coil spring 78 that urges the ink reservoir portion 67 is larger than a pressure loss that occurs downstream of the ink reservoir portion 67 while ink is consumed. Thus, when ink is further consumed at the recording head 12 from the state shown in FIG. 10, by the urging force of the coil spring 78 that urges the ink reservoir portion 67, ink in the ink reservoir portion 67 is supplied through the ink outlet port 72, the ink supply needle 28, the pump chamber 35, and the ink supply tube 37 to the recording head 12.

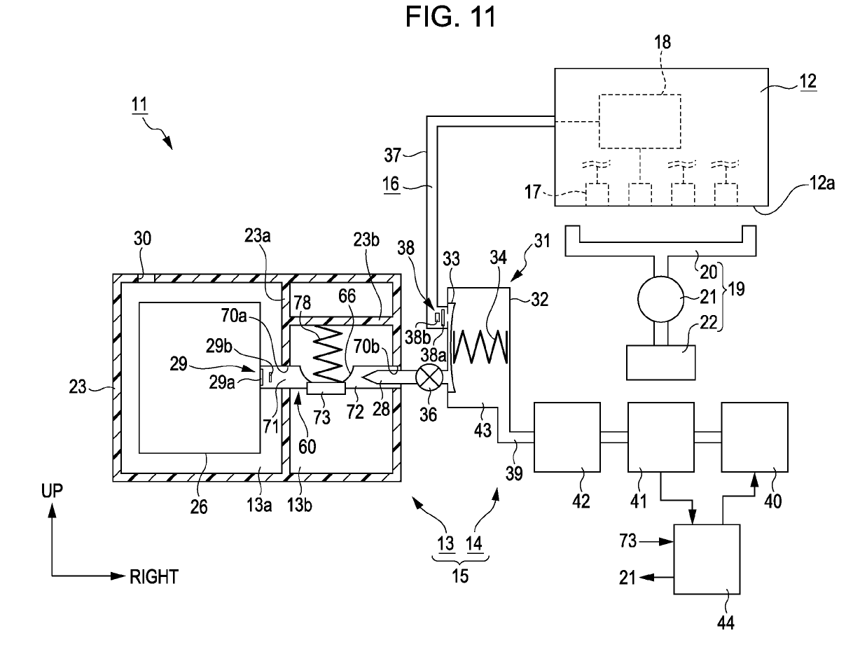

Then, as shown in FIG. 11, when ink in the ink reservoir portion 67 is discharged and then the ink level detecting portion 73 detects that the closing member 77 closes the ink guide passage 76, the controller 44 drives the vacuum pump 40 after the atmospheric relief valve 42 is closed. After that, the vacuum pump 40 generates a negative pressure, and the negative pressure chamber 43 of the pump 31, connected to the vacuum pump 40 through the air flow passage 39, is placed in a negative pressure state. Thus, the diaphragm 33 is elastically deformed (displaced) toward the negative pressure chamber 43 against the urging force of the coil spring 34 to reduce the volume of the negative pressure chamber 43. Then, with the reduction in volume of the negative pressure chamber 43, the pump chamber 35 of the pump 31 partitioned by the diaphragm 33 from the negative pressure chamber 43 increases in volume conversely.

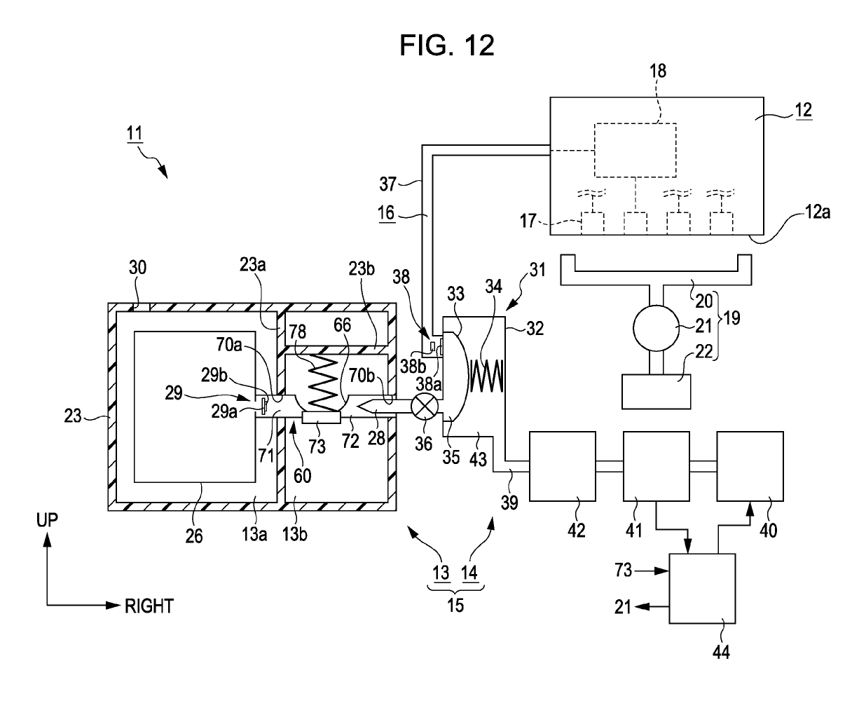

That is, as shown in FIG. 12, the pump 31 displaces the diaphragm 33 in a direction to increase the volume of the pump chamber 35 to perform vacuum driving. Thus, the inside of the pump chamber 35 is placed in a negative pressure state, and the negative pressure is applied from the downstream side to the valve element 29a that constitutes the second one-way valve 29 through the ink flow passage 16. Then, on the basis of a differential pressure with respect to an ink pressure applied from the ink bag 26 side, which is the upstream side of the second one-way valve 29, the valve element 29a is displaced rightward (in a direction to open the valve). As a result, the inside of the ink bag 26 communicates with the ink flow passage 16, and ink contained in the ink bag 26 is vacuumed through the ink flow passage 16 into the pump chamber 35 again.

On the other hand, when the pump 31 is driven for vacuuming, the negative pressure in the pump chamber 35 is also applied to the upstream side of the first one-way valve 38. Then, the valve element 38a is displaced rightward (in a direction to close the valve) on the basis of a differential pressure between the inside of the ink supply tube 37, which is the downstream side of the first one-way valve 38, and the pump chamber 35, which is the upstream side of the first one-way valve 38. As a result, the inside of the ink supply tube 37 is disconnected from the pump chamber 35.

Thereafter, in the state shown in FIG. 12, in order to determine whether the pump 31 initiates discharge driving, the pressure detector 41 detects a pressure accumulated in the negative pressure chamber 43 by driving the vacuum pump 40. Then, at the time when the detected pressure reaches a predetermined threshold, the controller 44 stops driving of the vacuum pump 40 to initiate discharge driving of the pump 31, while opening the atmospheric relief valve 42 to open the negative pressure chamber 43, placed in a negative pressure state, to the atmosphere. Then, the diaphragm 33 of the pump 31 is elastically deformed (displaced) by the urging force of the coil spring 34 toward the pump chamber 35 to increase the volume of the negative pressure chamber 43 (see FIG. 9). With the increase in volume of the negative pressure chamber 43, the pump chamber 35 of the pump 31, which is partitioned from the negative pressure chamber 43 by the diaphragm 33, reduces in volume conversely.

That is, the pump 31 displaces the diaphragm 33 in a direction to reduce the volume of the pump chamber 35 for discharge driving. Thus, ink is discharged from the inside of the pump chamber 35, and the discharge pressure is applied from the downstream side to the valve element 29a that constitutes the second one-way valve 29 through the ink supply needle 28, the ink outlet port 72, the ink reservoir portion 67 and the ink inlet port 71 on the upstream side with respect to the pump chamber 35 to thereby displace the valve element 29a in a direction to close the valve. As a result, the inside of the ink bag 26 is disconnected from the ink flow passage 16 due to the valve closing operation of the second one-way valve 29, and vacuuming of ink from the ink cartridge 13 to the pump chamber 35 through the second one-way valve 29 is stopped, while ink discharged from the pump chamber 35 in accordance with discharge driving of the pump 31 displaces the flexible film 66 in a direction to increase the volume of the ink reservoir portion 67.

On the other hand, during discharge driving of the pump 31, the pressure of ink discharged from the pump chamber 35 is applied to the upstream side of the first one-way valve 38. Thus, the discharge pressure of the pump 31 causes the closed valve element 38a to perform a valve opening operation, and, therefore, the pump chamber 35 communicates with the inside of the ink supply tube 37 through the first one-way valve 38. As a result, pressurized ink is supplied from the pump chamber 35 through the ink supply tube 37 to the valve unit 18.

After that, the pump 31 is driven for discharging as in the above manner, and ink is pressurized and supplied from the inside of the pump chamber 35 through the ink supply tube 37 to the recording head 12.

According to the sixth embodiment, the following advantageous effects may be obtained.

(1) When the pump 31 is driven, a pressure applied to the upstream side of the pump 31 varies. That is, a negative pressure is applied during vacuum driving by which ink is vacuumed from the ink cartridge 13 side toward the pump chamber 35. On the other hand, a positive pressure is applied during discharge driving by which ink is pressurized and supplied from the pump chamber 35. Thus, the flexible film 66 is displaced in accordance with the variation in pressure to increase and reduce the volume of the ink reservoir portion 67. Therefore, without providing a special configuration for displacing the flexible film 66, by detecting the state of ink in accordance with pump driving as a variation in volume of the ink reservoir portion 67, it is possible to determine the ink level. Thus, the number of components is reduced to suppress a complex configuration, and also it is possible to detect the ink level while contributing to reduction in size.

(2) Ink is pressurized and supplied to the ink reservoir portion 67 side in accordance with discharge driving of the pump 31 provided downstream of the ink reservoir portion 67, a positive pressure is applied to the ink reservoir portion 67. Thus, by converting application of the positive pressure into displacement of the flexible film 66, it is possible to improve the detection accuracy of ink level.

(3) A pressure applied to the flexible film 66 on the basis of the applied pressure of the coil spring 34 of the pump 31 is larger than a pressure applied to the flexible film 66 on the basis of the urging force of the coil spring 78 that urges the flexible film 66. Thus, utilizing the displacement of the flexible film 66 in accordance with the variation in applied pressure, it is possible to detect the level of ink contained in the ink bag 26.

(4) When ink is consumed at the recording head 12, an applied pressure in accordance with discharge driving of the pump 31 is larger than a pressure loss on the downstream side of the pump 31. Thus, it is possible to stably supply ink to the recording head 12 side.

(5) As the level of ink contained in the ink bag 26 is out, the pump 31 cannot perform vacuum driving in accordance with a negative pressure in the ink bag 26. That is, by forming the ink bag 26 as a closed space, it is possible to suppress the situation that a substance other than contained ink, such as air, is vacuumed after internal ink is supplied.

(6) By detecting the closed state of the ink guide passage 76 using the piezoelectric sensor 75, it is possible to determine whether the flexible film 66 and the closing member 77 are displaced to a position at which the ink guide passage 76 is closed. That is, it is possible to calculate the ink level in the ink bag 26 by determining whether there is an increase in volume of the ink reservoir portion 67.

(7) When the pump 31 is driven for vacuuming to vacuum ink into the pump chamber 35, ink is vacuumed from the ink bag 26 through the ink reservoir portion 67. On the other hand, when the pump 31 is driven for discharging, portion of ink discharged from the pump chamber 35 closes the second one-way valve 29 provided in the ink cartridge 13 and flows back to the ink reservoir portion 67 to increase the volume of the ink reservoir portion 67 against the urging force of the coil spring 78 that urges the flexible film 66. However, when ink in the ink bag 26 is completely supplied, the pump 31 is not able to vacuum ink even with vacuum driving, so ink cannot be discharged and a variation in volume of the ink reservoir portion 67 also does not occur. Thus, when the volume of the ink reservoir portion 67 does not vary, it may be determined that the level of ink in the ink bag 26 is zero.

(8) The ink cartridge 13 may be suitably used as an ink level detecting mechanism of the ink supply system 15.

(9) The printer 11 supplies ink to the recording head 12 side and detects the ink level to thereby make it possible to appropriately eject ink.

Note that the sixth embodiment may be modified as follows.

In the sixth embodiment, it is applicable that no partition wall 23a is provided by fixing the detecting element 60 to the case 23.

In the sixth embodiment, the second one-way valve 29, the flexible film 66 that constitutes the ink reservoir portion 67, and the like, may be integrally formed. That is, for example, inside the sensor accommodation chamber 13b, the detecting element 60 is formed so that an upstream-side recessed portion that has the ink inlet port 71 to open at the lower side and a downstream-side recessed portion that has the ink outlet port 72 to open at the upper side are laminated by placing the flexible film 66 in between. Then, the flexible film 66 has a communication hole that communicates the upstream-side recessed portion with the downstream-side recessed portion. Note that a projected portion is formed around the communication hole on the side of the flexible film 66, facing the upstream-side recessed portion. In this case, when the pump 31 is driven for discharging to apply a positive pressure to the downstream-side recessed portion, the flexible film 66 is displaced in a direction to approach the upstream-side recessed portion and then the upstream-side recessed portion contacts the projected portion to thereby close the communication hole. On the other hand, when the pump 31 is driven for vacuuming to apply a negative pressure to the downstream-side recessed portion, the flexible film 66 is displaced in a direction to approach the downstream-side recessed portion and then the upstream-side recessed portion communicates with the downstream-side recessed portion through the communication hole. Thus, ink in the ink bag 26 flows into the pump chamber 35. Furthermore, when the piezoelectric sensor 75 and the ink guide passage 76 are formed at a position of the upstream-side recessed portion, which contacts the projected portion, the ink level in the ink bag 26 may be detected.

In the sixth embodiment, it is applicable that the ink cartridge 13 does not include the ink bag 26 but contains ink in the ink container chamber 13a defined in the case 23.

In the sixth embodiment, the atmospheric communication hole 30 is formed in the case 23; however, as long as a space between the case 23 and the ink bag 26 is in an atmospheric state, a communication hole is unnecessary.

In the sixth embodiment, the ink level detecting portion 73 may employ an approach sensor (for example, a magnetic sensor) at the retaining wall 23b facing the flexible film 66 to detect a state of approaching of the flexible film 66.

### Seventh Embodiment

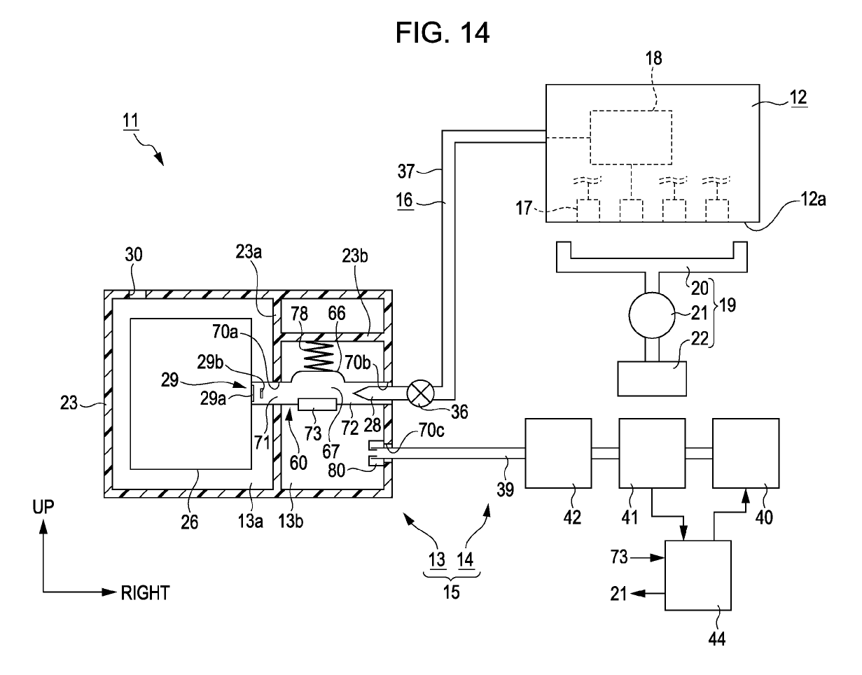

Next, further another configuration of detection of ink level in the printer 11 will be described with reference to FIG. 14 to FIG. 17B. In this case, the printer 11 differs from that of the sixth embodiment in the configuration of portions corresponding to the sensor accommodation chamber 13b of the ink cartridge 13 and the pump 31. Thus, the detailed description other than the different portions is omitted.

First, the ink cartridge 13 includes a case 23 made of synthetic resin material and formed into substantially a box shape. The inside of the case 23 is partitioned into two left and right spaces by the partition wall 23a, and, as shown in FIG. 14, the left-side space is the ink container chamber 13a. On the other hand, the right-side space forms the sensor accommodation chamber 13b, which serves as an airtight space, so as to be airtight.

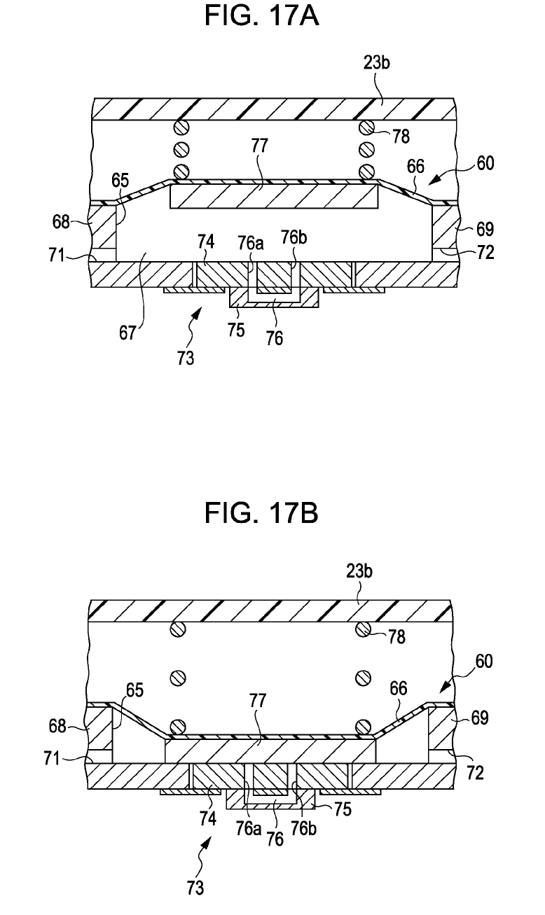

Then, when the pressure in the sensor accommodation chamber 13b is low, as shown in FIG. 17A, the flexible film 66 and closing member 77 of the detecting element 60 is displaced in a direction to increase the volume of the ink reservoir portion 67 against the urging force of the coil spring 78, which serves as an urging member in this case. On the other hand, when the negative pressure in the sensor accommodation chamber 13b is eliminated, as shown in FIG. 17B, the closing member 77 closely contacts the bottom plate 74 from above by the urging force of the coil spring 78. That is, the volume of the ink reservoir portion 67 is variable in such a manner that the closing member 77 and the flexible film 66 move in accordance with the pressure in the sensor accommodation chamber 13b.

Note that when such an ink cartridge 13 is connected to the ink supply device 14, the ink supply needle 28, which protrudes from the ink supply device 14 to form the upstream end of the ink flow passage 16, is inserted into the detecting element 60 through the ink outlet port 72. In addition, a through-hole 70c, through which the air flow passage 39 formed of a tube, or the like, may be inserted, is formed at a position below the through-hole 70b in the right wall of the case 23. Then, a connection member 80 is formed at a position corresponding to the periphery of the through-hole 70c in the sensor accommodation chamber 13b side on the right wall of the case 23. The connection member 80 airtightly connects the air flow passage 39 inserted into the through-hole 70c with the sensor accommodation chamber 13b.

That is, the air flow passage 39 is directly connected to the sensor accommodation chamber 13b of the ink cartridge 13 not through the pump 31 (FIG. 9) as described in the sixth embodiment. Similarly, the ink flow passage 16 is connected to the flow passage opening/closing valve 36 not through the pump 31 as described in the sixth embodiment. In addition, ink corresponding to the amount of ink consumed by ejecting ink from the nozzle 17 appropriately flows from the ink flow passage 16 to the valve unit 18. In terms of this point, the valve unit 18 serves as a one-way valve that only allows ink to pass from the upstream side, which is the ink cartridge 13 side, to the downstream side, which is the nozzle 17 side from which ink is ejected.

Next, the configuration of the ink supply device 14 will be described in detail. The vacuum pump 40, which serves as a negative pressure generating device, the pressure detector 41, and the atmospheric relief valve 42, which serves as a negative pressure releasing device, are connected to the sensor accommodation chamber 13b through the air flow passage 39. Note that the sensor accommodation chamber 13b, the vacuum pump 40 and the atmospheric relief valve 42 serve as an external force application device.

Of these, the vacuum pump 40 is driven to generate a negative pressure and also generates a negative pressure in the sensor accommodation chamber 13b connected through the air flow passage 39 to the vacuum pump 40. Thus, the inside of the airtight sensor accommodation chamber 13b maintains a negative pressure state by driving of the vacuum pump 40.

The pressure detector 41 detects a pressure in the sensor accommodation chamber 13b connected through the air flow passage 39, and outputs the detected result to the controller 44. Then, the controller 44, when the pressure in the sensor accommodation chamber 13b is lower than a predetermined threshold by driving the vacuum pump 40, stops driving of the vacuum pump 40, and opens the atmospheric relief valve 42 to open the inside of the sensor accommodation chamber 13b to the atmosphere to thereby eliminate a negative pressure state.

Thus, when the vacuum pump 40 is driven, in comparison with the ink reservoir portion 67 of which the internal pressure is held at a pressure higher than the atmospheric pressure in order to pressurize and supply ink, the pressure in the sensor accommodation chamber 13b reduces. Thus, the flexible film 66 is displaced in a direction to increase the volume of the ink reservoir portion 67 against the urging force of the coil spring 78.

Then, the ink reservoir portion 67 is placed in a negative pressure state and is lower in pressure than the ink bag 26 to which the atmospheric pressure is applied. Thus, the second one-way valve 29 is opened, and ink contained in the ink bag 26 is vacuumed through the ink inlet port 71 into the ink reservoir portion 67. Then, the controller 44 determines that the maximum amount of ink is vacuumed into the ink reservoir portion 67, and opens the atmospheric relief valve 42 to open the sensor accommodation chamber 13b to the atmosphere. After that, ink in the ink reservoir portion 67 is pressurized on the basis of the urging force of the coil spring 78 to close the second one-way valve 29, while the pressurized ink is supplied through the ink outlet port 72, the ink supply needle 28 and the ink supply tube 37 to the recording head 12.

That is, when the vacuum pump 40 is driven, the ink supply device 14 performs vacuum driving by which ink in the ink bag 26 is vacuumed and stored in the ink reservoir portion 67, while, when the atmospheric relief valve 42 is open, the ink supply device 14 performs discharge driving by which the stored ink is discharged to the downstream side.

However, even when the vacuum pump 40 is driven and, therefore, the sensor accommodation chamber 13b is placed in a negative pressure state, when the amount of ink contained in the ink bag 26 reduces, the amount of ink vacuumed to the ink reservoir portion 67 reduces. Thus, an increase in volume of the ink reservoir portion 67 is suppressed. Then, in the seventh embodiment, during vacuum driving, an ink end state in which ink in the ink bag 26 is out is set to a state in which the closing member 77 is not displaced from a position at which the closing member 77 contacts the bottom plate 74 and the ink guide passage 76 is closed.

Next, an ink end determination method for determining a state in which the amount of ink in the ink bag 26 is zero will be described. As shown in FIG. 17B, when the closing member 77 contacts the bottom plate 74, the opening portions 76a and 76b of the ink guide passage 76 are closed by the closing member 77. On the other hand, as shown in FIG. 17A, when the closing member 77 is located away from the bottom plate 74, the ink guide passage 76 is open to the ink reservoir portion 67 through the opening portions 76a and 76b.

The inside of the ink guide passage 76 is filled with ink, and the piezoelectric sensor 75 detects different states of free oscillation when the ink guide passage 76 is closed by the closing member 77 and when the ink reservoir portion 67 is open. That is, the ink level detecting portion 73 executes a detecting operation to detect whether the closing member 77 contacts the bottom plate 74 and the volume of the ink reservoir portion 67 is smaller than or equal to a predetermined amount. Thus, the ink level detecting portion 73 detects the amount of ink in the ink reservoir portion 67, and outputs a detected result for determining the amount of ink in the ink bag 26. In addition, the piezoelectric sensor 75 is communicable with the controller 44 provided for the printer 11. The controller 44 serves as a liquid level detector that calculates the ink level in the ink bag 26 on the basis of the detected result and detects an ink end state in which ink is out on the basis of the calculated ink level.

Then, next, the operation of the thus configured printer 11 will be described particularly focusing on the operation of the ink supply system 15. First, it is assumed that FIG. 14 shows a state in which ink is sufficient in the ink flow passage 16 and the atmospheric relief valve 42 is open. That is, the flexible film 66 is urged by the coil spring 78 in a direction to reduce the volume of the ink reservoir portion 67 to thereby apply a pressure to ink in the ink reservoir portion 67. Thus, the valve element 29a of the second one-way valve 29 is displaced leftward (in a direction to close the valve) on the basis of a differential pressure between the atmospheric pressure applied to ink contained in the ink bag 26 and the atmospheric pressure and urging force applied to ink in the ink reservoir portion 67.

On the other hand, on the downstream of the ink reservoir portion 67, pressurized ink in the reservoir portion 67 is supplied through the ink outlet port 72, the ink supply needle 28 and the ink supply tube 37 to the recording head 12.

That is, the discharge pressure of ink that is pressurized by the flexible film 66 and discharged from the ink reservoir portion 67 is maintained uniformly on the downstream side of the second one-way valve 29. Then, when ink is ejected from the nozzle 17 toward the target, ink corresponding to the amount of ink consumed in accordance with the ink ejection is supplied under pressure from the ink flow passage 16 through the valve unit 18 to the nozzle 17 side.

Note that the inside of the ink reservoir portion 67 is pressurized by the urging force of the coil spring 78, so it is possible to maintain the pressurized state without providing an additional device for pressurizing the inside of the ink reservoir portion 67. In addition, when a device that has both the function of a pressure generating device and the function of a negative pressure generating device is employed to pressurize the inside of the ink reservoir portion 67, a complex control configuration for maintaining the pressurized state inside the ink reservoir portion 67 is necessary; however, when the coil spring 78 is employed as a device for pressurizing and supplying ink, it is possible to simply maintain the pressurized state inside the ink reservoir portion 67.

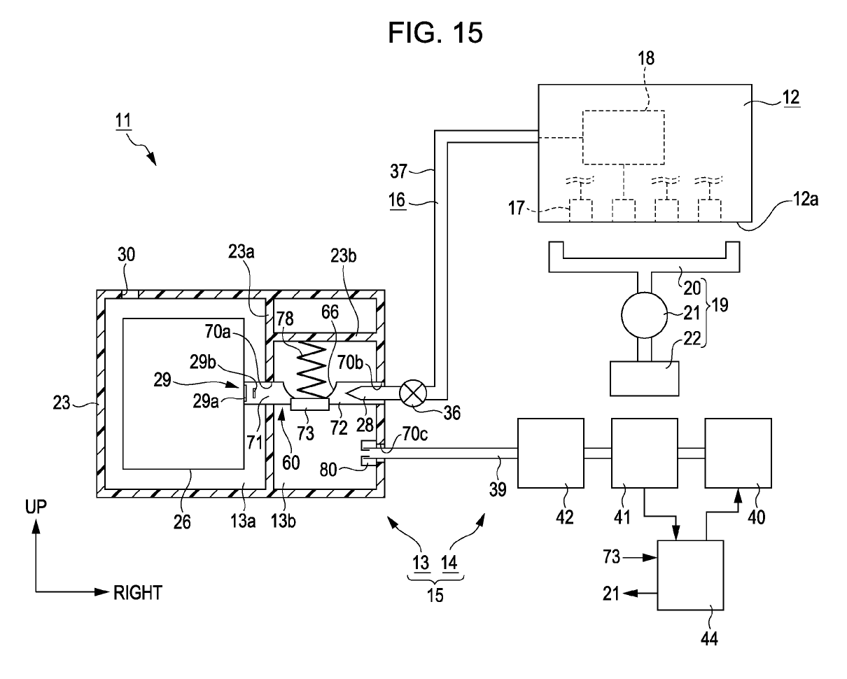

Then, as a result of consumption of ink at the downstream side (recording head 12 side), the volume of the ink reservoir portion 67 gradually reduces, and finally the flexible film 66 is displaced to a position at which the volume of the ink reservoir portion 67 is minimal. At this time, the closing member 77 fixedly connected to the flexible film 66 contacts the bottom plate 74 to close the opening portions 76a and 76b (see FIG. 15 and FIG. 17B).

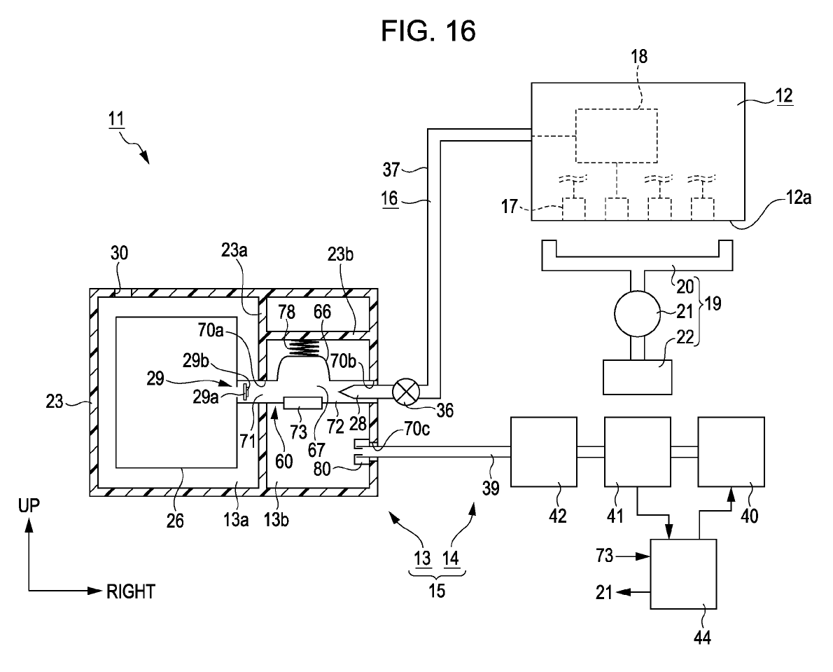

Then, as the ink level detecting portion 73 detects that the closing member 77 closes the ink guide passage 76, the controller 44 drives the vacuum pump 40 after the atmospheric relief valve 42 is closed. After that, the vacuum pump 40 generates a negative pressure, and the sensor accommodation chamber 13b, connected to the vacuum pump 40 through the air flow passage 39, is placed in a negative pressure state. Thus, the flexible film 66 is elastically deformed (displaced) upward against the urging force of the coil spring 78 to increase the volume of the ink reservoir portion 67 (see FIG. 16). Thus, the inside of the ink reservoir portion 67 is placed in a negative pressure state, and the negative pressure is applied from the downstream side to the valve element 29a that constitutes the second one-way valve 29 through the ink inlet port 71. Then, on the basis of a differential pressure with respect to an ink pressure applied from the ink bag 26 side, which is the upstream side of the second one-way valve 29, the valve element 29a is displaced rightward (in a direction to open the valve). As a result, the inside of the ink bag 26 communicates with the ink reservoir portion 67, and ink contained in the ink bag 26 is vacuumed through the ink inlet port 71 to the ink reservoir portion 67. That is, the ink supply device 14 performs vacuum driving.

Then, in order to determine whether the vacuum pump 40 is stopped, the pressure detector 41 detects a pressure accumulated in the sensor accommodation chamber 13b. Then, at the time when the detected pressure reaches a predetermined threshold, the controller 44 stops driving of the vacuum pump 40, while opening the atmospheric relief valve 42 to open the sensor accommodation chamber 13b, placed in a negative pressure state, to the atmosphere. After that, the flexible film 66 is urged by the coil spring 78 to apply a pressure to ink in the ink reservoir portion 67 (see FIG. 14). After that, the ink supply device 14 is driven for discharging as in the above manner, and ink is pressurized and supplied from the inside of the ink reservoir portion 67 through the ink supply tube 37 to the recording head 12.

According to the seventh embodiment, the following advantageous effects may be obtained. (1) When the vacuum pump 40 reduces the pressure in the sensor accommodation chamber 13b to displace the flexible film 66 in a direction to increase the volume of the ink reservoir portion 67, a negative pressure is generated in the ink reservoir portion 67, and then ink flows from the ink bag 26 through the second one-way valve 29. In this state, when the vacuum pump 40 is stopped and the atmospheric relief valve 42 is opened, the ink reservoir portion 67 receives the urging force from the coil spring 78 to reduce the volume of the ink reservoir portion 67. At this time, because the flow is blocked by the second one-way valve 29 on the upstream side of the ink reservoir portion 67, ink flows out to the recording head 12 side. Thus, ink is supplied from the ink cartridge 13 through the ink flow passage 16 to the nozzle 17 of the recording head 12, at which ink is consumed. Thus, the number of components is reduced to suppress a complex configuration, and also it is possible to pressurize and supply ink while contributing to reduction in size.

(2) When the vacuum pump 40 places the sensor accommodation chamber 13b in a negative pressure state, a differential pressure occurs between the ink reservoir portion 67 side and sensor accommodation chamber 13b side of the flexible film 66. Thus, the flexible film 66 is displaced toward the sensor accommodation chamber 13b, that is, in a direction to increase the volume of the ink reservoir portion 67 against the urging force of the coil spring 78. Therefore, the negative pressure generated in the sensor accommodation chamber 13b is propagated to the ink reservoir portion 67 and then ink flows from the ink bag 26 into the ink reservoir portion 67. Then, when the atmospheric relief valve 42 is opened to eliminate the negative pressure state of the sensor accommodation chamber 13b, the volume of the ink reservoir portion 67 reduces on the basis of the urging force of the coil spring 78 to thereby make it possible to pressurize and supply ink.

(3) When the level of ink contained in the ink bag 26 is out, because a negative pressure in the ink bag 26 increases due to a negative pressure generated in the ink reservoir portion 67, so the ink reservoir portion 67 is not able to increase in volume. That is, by forming the ink bag 26 as a closed space, it is possible to suppress the situation that a substance other than contained ink, such as air, is vacuumed after internal ink is supplied.

(4) By detecting the closed state of the ink guide passage 76 using the piezoelectric sensor 75, it is possible to determine whether the closing member 77 is displaced to a position at which the ink guide passage 76 is closed. That is, it is possible to calculate the ink level in the ink bag 26 by determining whether there is an increase in volume of the ink reservoir portion 67 by the flexible film 66 that is displaced together with the closing member 77.

(5) In a state where the volume of the ink bag 26 is reduced, ink that may be supplied to the recording head 12 side is also reduced. Thus, in a case where the volume of the ink reservoir portion 67 is reduced, the flexible film 66 is displaced in a direction to increase the volume of the ink reservoir portion 67, a negative pressure is generated in the ink reservoir portion 67. Hence, by flowing ink from the ink bag 26 into the ink reservoir portion 67 using the negative pressure, ink that may be supplied to the recording head 12 side is increased to thereby make it possible to stably supply ink.

(6) When the vacuum pump 40 is driven to reduce the pressure in the sensor accommodation chamber 13b to thereby increase the volume of the ink reservoir portion 67, a negative pressure is generated in the ink reservoir portion 67. Thus, in accordance with the generation of the negative pressure, ink flows into the ink reservoir portion 67. On the other hand, when driving of the vacuum pump 40 is stopped to open the atmospheric relief valve 42, the inside of the sensor accommodation chamber 13b is reduced to an atmospheric pressure. Thus, ink in the ink reservoir portion 67 receives the urging force of the coil spring 78 and is supplied through the ink flow passage 16 to the recording head 12 side. However, when ink in the ink bag 26 is completely supplied, even when the vacuum pump 40 is driven to place the sensor accommodation chamber 13b in a negative pressure state, it is impossible to flow ink into the ink reservoir portion 67. Thus, displacement of the flexible film 66 does not occur, and the volume of the ink reservoir portion 67 does not vary. Thus, when the volume of the ink reservoir portion 67 does not vary, it may be determined that the level of ink in the ink bag 26 is zero.

(7) Driving of the vacuum pump 40 is stopped when the ink level is zero. Thus, it is possible to reduce an excessive load on the ink supply tube 37 that constitute the ink flow passage 16, and components that constitute the vacuum pump 40 and the air flow passage 39, or the like. Furthermore, the ink cartridge 13 may be detached from the ink supply needle 28 without applying external force. Thus, when it is determined to be an ink end state in which ink cannot be supplied, it is possible to detach and replace the ink cartridge 13 with a new ink cartridge 13. In addition, it is possible to improve the efficiency of supply of ink against driving of the vacuum pump 40.

(8) In order to suppress backflow of ink from the downstream side, which is the nozzle 17 side, to the upstream side, which is the ink cartridge 13 side, when the volume of the ink reservoir portion 67 is increased to generate a negative pressure inside, the valve unit 18 suppresses inflow of ink from the downstream side of the ink flow passage 16 to the ink reservoir portion 67. Thus, ink of an amount corresponding to an increase in volume flow from the ink bag 26 into the ink reservoir portion 67, and, during supply of ink, the above ink passes the valve unit 18 and is supplied to the nozzle 17 side. Hence, it is possible to improve the efficiency of supply of ink.

(9) The ink supply needle 28 that constitutes the upstream end of the ink flow passage 16 in the ink supply system 15 is connected to the through-hole 70b of the ink cartridge 13. Thus, the ink cartridge 13 may be used as a liquid supply source that is able to stably pressurize and supply ink to the recording head 12 side at which ink is consumed.

(10) The printer 11 supplies ink to the recording head 12 side and detects the ink level to thereby make it possible to appropriately eject ink.

### Eighth Embodiment

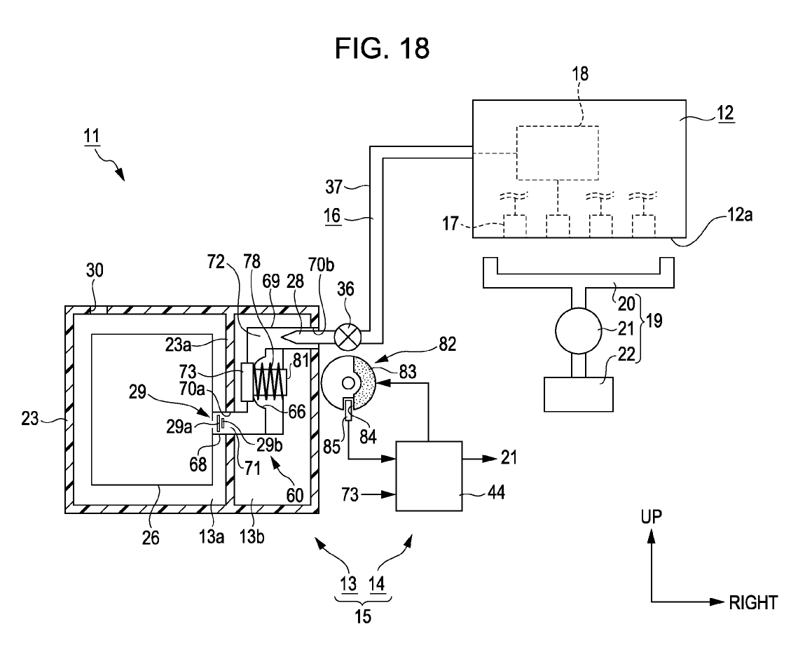

Next, an eighth embodiment will be described with reference to FIG. 18 to FIG. 20B. Note that the eighth embodiment differs from the seventh embodiment in a configuration related to the sensor accommodation chamber 13b and an external force application device that applies external force to displace the flexible film 66, and the other configuration is the same. Thus, like reference numerals denote like components, and the detailed description thereof will not be repeated.

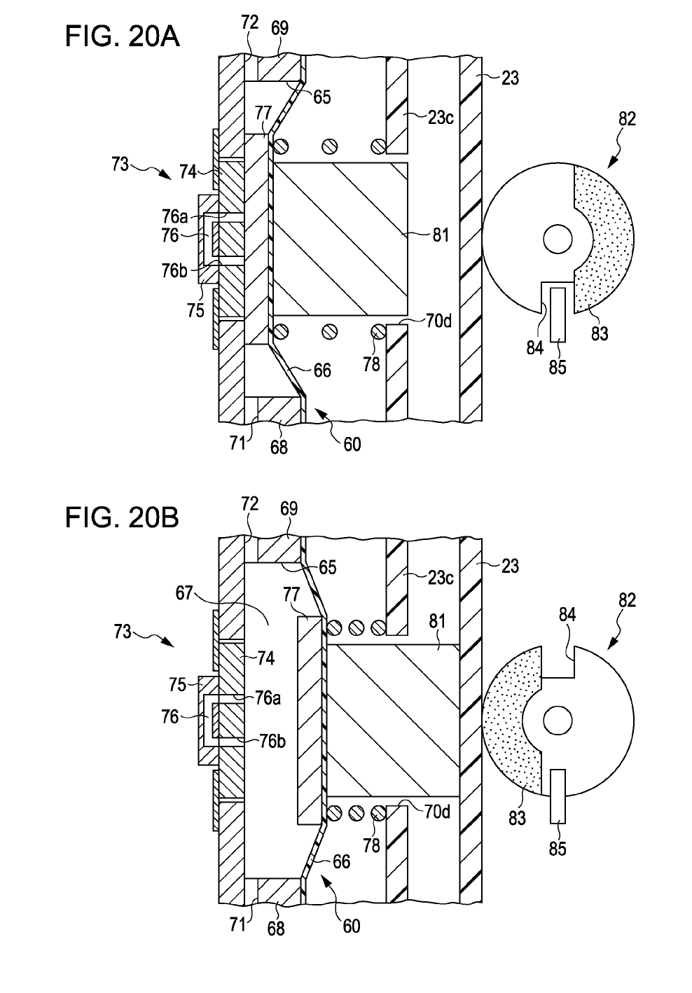

As shown in FIG. 18, FIG. 20A and FIG. 20B, the sensor accommodation chamber 13b accommodates substantially a disk-shaped detecting element 60 having a thickness horizontally in FIG. 18. As shown in FIG. 20A and FIG. 20B, the detecting element 60 has a recessed portion 65 that opens rightward, and a flexible film 66 is fixedly connected on the right end of the recessed portion 65 so as to seal the opening of the recessed portion 65 with some deflection.

An inflow-side protrusion 68 is provided so as to bend leftward as shown in FIG. 18 at the lower end side of the detecting element 60, and an outflow-side protrusion 69 is provided so as to bend rightward as shown in FIG. 18 at the upper end side of the detecting element 60. In addition, the partition wall 23a has the through-hole 70a, and the through-hole 70b, through which the ink supply needle 28 is inserted, is formed in the right wall of the case 23 at a horizontally different position from the through-hole 70a.

Then, the inflow-side protrusion 68 and the outflow-side protrusion 69 are respectively fitted into the through-holes 70a and 70b, so the detecting element 60 is supported on the case 23. In addition, the inflow-side protrusion 68 has the ink inlet port 71 that is formed therethrough so as to communicate the ink reservoir portion 67 with the ink bag 26. Then, the outflow-side protrusion 69 has the ink outlet port 72 that is formed therethrough to communicate with the ink reservoir portion 67.

In addition, the ink level detecting portion 73 is provided at the left portion of the detecting element 60, which is the bottom of the recessed portion 65, and the closing member (see FIG. 20A and FIG. 20B) 77 is fixedly connected to the left surface side of the flexible film 66, which faces the ink level detecting portion 73. On the other hand, a retaining wall 23c is provided at the right side of the flexible film 66 at a position between the right wall of the case 23 and the flexible film 66 so as to be supported by the detecting element 60 parallel to the right wall. Then, a coil spring 78 is held between the right surface of the flexible film 66 and the retaining wall 23c so as to elastically urge the closing member 77 and the flexible film 66 in a direction to reduce the volume of the ink reservoir portion 67.

In addition, a through-hole 70d is formed in the retaining wall 23c at a position inside the coil spring 78, and a cylindrical magnetic substance (for example, iron block) 81 having a diameter smaller than the through-hole 70d is fixedly connected to the right surface of the flexible film 66 at a position corresponding to the through-hole 70d. Then, the magnetic substance 81 is configured to reciprocally move in a direction in which the coil spring 78 extends and contracts (horizontally in FIG. 18) in accordance with a displacement of the flexible film 66 in a state where the distal end side of the magnetic substance 81 is inserted into the through-hole 70d of the retaining wall 23c.

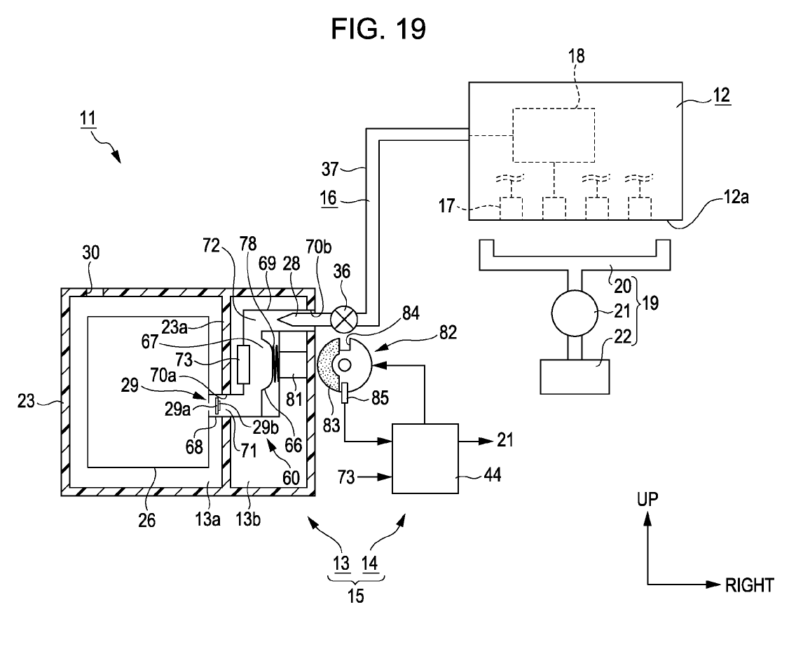

Next, the configuration of the ink supply device 14 will be described in detail. Outside the ink cartridge 13, at a position that horizontally corresponds to the magnetic substance 81 with the right wall of the ink cartridge 13 placed in between, a rotating member 82, which serves as a magnetic force generating device that is connected to a motor (not shown) and driven for rotation, is provided adjacent to the right wall of the ink cartridge 13. Note that substantially half (right half in FIG. 18) of the rotating member 82 is formed of a magnet 83. Then, as shown in FIG. 18 and FIG. 20A, in the rotating position of the rotating member 82, when the magnet 83 is placed away from the right wall of the ink cartridge 13 (that is, from the magnetic substance 81 in the ink cartridge 13), the urging force of the coil spring 78 is larger than the vacuum force that the magnetic force of the magnet 83 is applied to the magnetic substance 81. On the other hand, as shown in FIG. 20B, when the magnet 83 is rotated to a position adjacent to the right wall of the ink cartridge 13 in accordance with the rotation of the rotating member 82, the vacuum force that the magnetic force of the magnet 83 is applied to the magnetic substance 81 is larger than the urging force of the coil spring 78. Thus, as shown in FIG. 19, the magnetic substance 81 is attracted toward the magnet 83 against the urging force of the coil spring 78, and the flexible film 66 fixedly connected to the magnetic substance 81 is displaced rightward together with the magnetic substance 81. In terms of this point, the magnetic substance 81, the rotating member 82 and the magnet 83 serve as an external force application device.

Thus, when the rotating member 82 is driven for rotation, the flexible film 66 is displaced to vary the volume of the ink reservoir portion 67, so the pressure in the ink reservoir portion 67 varies to generate a differential pressure between both sides of the second one-way valve 29. When the magnet 83 approaches the ink cartridge 13 to increase the volume of the ink reservoir portion 67, the ink reservoir portion 67 is placed in a negative pressure state. Thus, the pressure in the ink reservoir portion 67 is lower than that of the ink bag 26 to which the atmospheric pressure is applied, and the second one-way valve 29 is opened and then ink contained in the ink bag 26 is vacuumed through the ink inlet port 71 into the ink reservoir portion 67. After that, when the rotating member 82 is further driven for rotation and then the magnet 83 is moved away from the right wall of the ink cartridge 13, the coil spring 78 pressurizes ink in the ink reservoir portion 67 to close the second one-way valve 29. Furthermore, the pressurized ink is supplied through the ink outlet port 72, the ink supply needle 28 and the ink supply tube 37 to the recording head 12.

That is, when the magnetic substance 81 in the ink cartridge 13 is located close to the magnet 83, the ink supply device 14 performs vacuum driving by which ink in the ink bag 26 is vacuumed and stored in the ink reservoir portion 67, while, when the magnetic substance 81 in the ink cartridge 13 is spaced apart from the magnet 83, the ink supply device 14 performs discharge driving by which the stored ink is discharged to the downstream side.

In addition, the rotating member 82 has a slit 84 extending from the lower-side periphery to the center in FIG. 18, and a sensor (for example, photosensor) 85 that detects passage of the slit 84 is provided within the range of movement of the slit 84. That is, as shown in FIG. 18, in a state where the attraction force of the magnet 83 applied to the magnetic substance 81 is smaller than the urging force of the coil spring 78, for example, a ray of light emitted from a light source (not shown) passes through the slit 84 and is detected by the sensor 85. On the other hand, as shown in FIG. 19, in a state where the attraction force of the magnet 83 applied to the magnetic substance 81 is larger than the urging force of the coil spring 78, a ray of light emitted from the light source is blocked by the rotating member 82 and is not detected by the sensor 85.

Then, next, the operation of the thus configured printer 11 will be described particularly focusing on the operation of the ink supply system 15. First, it is assumed that FIG. 18 shows a state immediately after replacement to a new ink cartridge 13, the flexible film 66 is displaced leftward at the left side of the detecting element 60 by the urging force of the coil spring 78, and the ink level detecting portion 73 is in contact with the closing member 77. Note that because there is no differential pressure between the ink inlet port 71 and the ink bag 26, the valve element 29a of the second one-way valve 29 is not positioned.

Then, in the state shown in FIG. 18, when the ink supply device 14 supplies ink from the ink cartridge 13 to the recording head 12 side, first, the controller 44 drives the rotating member 82 for rotation in order to open the flow passage opening/closing valve 36 and drives the ink supply device 14 for vacuuming. Then, the magnet 83 approaches the right wall of the ink cartridge 13 (that is, the magnetic substance 81 in the ink cartridge 13), and attracts the magnetic substance 81 and the flexible film 66 toward the rotating member 82 against the urging force of the coil spring 78. Thus, the volume of the ink reservoir portion 67 increases to place the ink reservoir portion 67 in a negative pressure state, so the second one-way valve 29 is opened and then ink contained in the ink bag 26 flows through the ink inlet port 71 into the ink reservoir portion 67 (see FIG. 19 and FIG. 20B).

On the other hand, during vacuum driving of the ink supply device 14, a negative pressure of the ink reservoir portion 67 is also applied to the upstream side of the valve unit 18. However, the valve unit 18 is configured so that the valve unit 18 is regularly closed and the closed state is not changed into an open state unless ink is ejected from the nozzle 17 of the recording head 12. Thus, in this case, the valve unit 18 is maintained in its closed state.

Moreover, as the rotating member 82 is rotated to move the magnet 83 away from the right wall of the ink cartridge 13 (that is, the magnetic substance 81 in the ink cartridge 13), the attraction force of the magnet 83 applied to the magnetic substance 81 decreases and then the urging force of the coil spring 78 becomes larger than the attraction force. That is, the ink supply device 14 displaces the flexible film 66 in a direction to reduce the volume of the ink reservoir portion 67 to perform discharge driving. Thus, ink is discharged from the inside of the ink reservoir portion 67, and the discharge pressure is applied from the downstream side to the valve element 29a of the second one-way valve 29 through the ink inlet port 71 on the upstream side with respect to the ink reservoir portion 67 to thereby displace the valve element 29a in a direction to close the valve. As a result, the inside of the ink bag 26 is disconnected from the ink flow passage 16 due to the valve closing operation of the second one-way valve 29, and vacuuming of ink from the ink bag 26 to the ink reservoir portion 67 through the second one-way valve 29 is stopped, while ink discharged from the ink reservoir portion 67 in accordance with discharge driving of the ink supply device 14 is restricted from flowing back through the second one-way valve 29 to the ink bag 26 side.

Note that when the sensor 85 detects one complete rotation of the rotating member 82, the controller 44 stops driving of the rotating member 82 for rotation. Thus, ink of an amount corresponding to the ink consumed at the recording head 12 is pressurized and supplied on the basis of the urging force of the coil spring 78, and then the volume of the ink reservoir portion 67 gradually reduces. Then, finally, the flexible film 66 is displaced to a position at which the volume of the ink reservoir portion 67 is minimal, and the closing member 77 fixedly connected to the flexible film 66 contacts the bottom plate 74 to close the opening portions 76a and 76b.

When the controller 44 determines that the closing member 77 closes the ink guide passage 76 on the basis of the detected result of the ink level detecting portion 73, the controller 44 drives the rotating member 82 for rotation. Then, the magnet 83 approaches the right wall of the ink cartridge 13 (that is, the magnetic substance 81 in the ink cartridge 13), and, after that, the ink supply device 14 is driven for vacuuming as in the above described manner. Thus, ink flows from the ink bag 26 into the ink reservoir portion 67.

According to the eighth embodiment, in addition to the advantageous effects of the seventh embodiment, the following advantageous effects may be further obtained.

(1) Because the rotating member 82 having the magnet 83 face the magnetic substance 81 in a direction in which the flexible film 66 is displaced, when, in accordance with driving of the rotating member 82 for rotation, the magnet 83 approaches the right wall of the ink cartridge 13 (that is, the magnetic substance 81 in the ink cartridge 13) and, as a result, the attraction force that is larger than the urging force of the coil spring 78 is applied to the magnetic substance 81, the magnetic substance 81 is displaced toward the magnet 83 and, at the same time, the flexible film 66, which is displaced together with the magnetic substance 81, increases the volume of the ink reservoir portion 67. Thus, a negative pressure is generated in the ink reservoir portion 67, and ink flows from the ink bag 26 into the ink reservoir portion 67. On the other hand, when the magnet 83 of the rotating member 82 is rotated to a position spaced apart from the ink cartridge 13 and, as a result, the attraction force applied to the magnetic substance 81 is small, because the volume of the ink bag 26 is reduced by the urging force of the coil spring 78, it is possible to pressurize and supply ink.

(2) By rotating the rotating member 82 to vary the distance between the magnetic substance 81 and the magnet 83, it is possible to vary the attraction force applied to the magnetic substance 81. That is, when the magnetic substance 81 is brought close to the magnet 83, due to the attraction force applied to the magnetic substance 81, the magnetic substance 81, together with the flexible film 66, is attracted toward the magnet 83 to increase the volume of the ink reservoir portion 67. On the other hand, when the magnet 83 is moved away from the magnetic substance 81, because the attraction force applied to the magnetic substance 81 reduces, the flexible film 66 is displaced in a direction to move away from the magnet 83 by the urging force of the coil spring 78. Thus, because the volume of the ink reservoir portion 67 may be easily varied, time required for ensuring ink that can be supplied to the recording head 12 is reduced, and it is possible to quickly switch between supply of ink and inflow of ink into the ink reservoir portion 67.

Note that the above seventh and eighth embodiments may be modified as follows.

In the seventh embodiment, the coil spring 78 that applies a predetermined urging force to the flexible film 66 may displace the flexible film 66 so that a weight is provided for the flexible film 66 and the flexible film 66 is displaced downward in FIG. 14 by the action of gravity. In addition, in the eighth embodiment, by installing the ink cartridge 13 so that gravity is applied leftward in FIG. 18, the magnetic substance 81 may be used as an urging member that urges the flexible film 66 in a direction to reduce the volume of the ink reservoir portion 67 on the basis of the weight.

In the seventh and eighth embodiments, the one-way valve, which is integrally formed with the valve unit 18, may be separately provided in the ink flow passage 16, which is the downstream side with respect to the ink reservoir portion 67.

In the seventh and eighth embodiments, it is applicable that, even when it is detected as an ink end state, driving of the vacuum pump 40 and rotating member 82 is continued to further reduce the amount of ink remaining in the ink bag 26.

In the seventh and eighth embodiments, it is applicable that no ink level detecting portion 73 is provided.

In the seventh and eighth embodiments, the timing at which the vacuum pump 40 and the rotating member 82 are driven may be after a predetermined period of time has elapsed or may be determined on the basis of the amount of ink consumed at the recording head 12, or the like.

In the seventh embodiment, the ink level detecting portion 73 may employ an approach sensor (for example, a magnetic sensor) at the retaining wall 23b facing the flexible film 66 to detect a state of approaching of the flexible film 66. In addition, in the eighth embodiment, it is applicable that an approach sensor that detects an approach of the magnetic substance 81 or two electrodes, that is, a positive electrode and a negative electrode, are provided on the inner surface of the right wall of the case 23, and then, when the flexible film 66 is varied in a direction to increase the volume of the ink reservoir portion 67, the electrodes contact the magnetic substance 81. That is, an energized state through the magnetic substance 81 may be detected.

In the seventh and eighth embodiments, it is applicable that the ink cartridge 13 does not include the ink bag 26 but contains ink in the ink container chamber 13a defined in the case 23.

In the seventh and eighth embodiments, the atmospheric communication hole 30 is formed in the case 23; however, as long as a space between the case 23 and the ink bag 26 is in an atmospheric state, a communication hole is unnecessary.

In the eighth embodiment, the magnetic force generating device that applies the attraction force to the magnetic substance 81 may be variable in magnitude of the attraction force applied to the magnetic substance 81 using an electromagnet.

Furthermore, the first to eighth embodiments may be modified as follows.

In the first to eighth embodiments, the “liquid” also includes liquid other than ink (including inorganic solvent, organic solvent, solution, liquid resin, liquid metal (metal melt), and the like), a liquid element in which particles of functional material are dispersed or mixed in liquid, and a fluid element such as gel. Then, the liquid ejecting apparatus provided with the ink supply system 15 is embodied as the ink jet printer 11; however, it is not limited. The aspects of the invention may be embodied as a liquid ejecting apparatus that ejects liquid other than ink (including a liquid element in which particles of functional material are dispersed). The liquid ejecting apparatus that ejects or discharges such “liquid” may be, for example, a liquid element ejecting apparatus, which ejects a liquid element that contains materials such as electrode materials or color materials (pixel materials), used for manufacturing a liquid crystal display, an electroluminescence (EL) display and a field emission display, or the like, in the form of dispersion or solution, a liquid ejecting apparatus, which ejects a bio-organic material, used for manufacturing a bio-chip, or a liquid ejecting apparatus, which ejects a liquid as a sample, used as a precision pipette. Furthermore, the aspects of the invention may be embodied as a liquid ejecting apparatus that ejects a lubricating oil pinpoint to a precision machine, such as a clock, a watch or a camera, a liquid ejecting apparatus that ejects a transparent resin liquid, such as an ultraviolet curing resin, for forming a microscopic semi-spherical lens (optical lens) used for an optical communication element, or the like, on a substrate, a liquid ejecting apparatus that ejects an etchant, such as acid or alkali, in order to perform etching on the substrate, or the like, or a fluid element ejecting apparatus that ejects a fluid element, such as a gel (for example, physical gel). In addition, the ink cartridge 13 is embodied as the ink jet printer 11; instead, the ink cartridge 13 may be applied as a liquid supply source that stores liquid used in an apparatus other than the printer 11 and supplies the stored liquid to a liquid consuming portion that requires the liquid.

In the first to eighth embodiments, the flow passage opening/closing valve 36 may be a valve having another valve structure other than those of the above embodiments as long as the configuration is able to suppress leakage of ink from the ink supply needle 28 when the ink cartridge 13 is detached from the ink supply device 14. For example, the flow passage opening/closing valve 36 may be formed of a one-way valve that suppresses flow of ink in a direction in which ink leaks from the ink supply needle 28 (that is, in a direction from the downstream side of the ink flow passage 16 toward the upstream side), while allowing flow of ink from the ink supply needle 28 to the pump chamber 35 side (that is, in a direction from the upstream side of the ink flow passage 16 toward the downstream side).

What is claimed is:

1. A liquid supply system includes:
a liquid supply source that has a liquid container portion that accommodates liquid inside and a liquid delivery portion that delivers the liquid outside;
a liquid supply flow passage that supplies the liquid from an upstream side, which is a side of the liquid supply source, toward a downstream side at which the liquid is consumed;
a pump that is driven using portion of the liquid supply flow passage as a pump chamber;
a first one-way valve that is provided in the liquid supply flow passage at a position downstream of the pump chamber and that only allows the liquid to pass from the upstream side to the downstream side; and
a second one-way valve that is provided in the liquid supply source and that only allows the liquid to pass from an upstream side, which is a side of the liquid container portion, to a downstream side, which is a side of the liquid delivery portion.

2. The liquid supply system according to claim 1, further comprising any one of a differential pressure regulating valve or a pressure reducing valve provided in the liquid supply source between the liquid container portion and the liquid delivery portion, wherein
the differential pressure regulating valve switches between open/closed states on the basis of a differential pressure between a liquid pressure on the side of the liquid container portion and a liquid pressure on the side of the liquid delivery portion, wherein
the pressure reducing valve switches between open/closed states on the basis of a negative pressure applied from a downstream side to the side of the liquid delivery portion inside the liquid supply source, and wherein
the second one-way valve doubles as the differential pressure regulating valve or doubles as the pressure reducing valve.

3. The liquid supply system according to claim 1, further comprising: any one of a differential pressure regulating valve or a pressure reducing valve provided in the liquid supply source between the liquid container portion and the liquid delivery portion, wherein
the differential pressure regulating valve switches between open/closed states on the basis of a differential pressure between a liquid pressure on the side of the liquid container portion and a liquid pressure on the side of the liquid delivery portion, wherein
the pressure reducing valve switches between open/closed states on the basis of a negative pressure applied from a downstream side to the side of the liquid delivery portion inside the liquid supply source, and wherein
the second one-way valve is provided in the liquid supply source between the liquid delivery portion and the differential pressure regulating valve or in the liquid supply source between the liquid delivery portion and the pressure reducing valve.

4. The liquid supply system according to claim 1, further comprising a flow passage opening/closing valve that is provided in the liquid supply flow passage between the pump chamber and the liquid delivery portion of the liquid supply source and that is able to open and close the liquid supply flow passage.

5. The liquid supply system according to claim 1, wherein the liquid supply source is a flexible liquid container bag, and an inner closed space of the liquid container bag is the liquid container portion.

6. The liquid supply system according to claim 1, wherein the liquid supply source has an atmospheric communication hole that communicates the liquid container portion with the atmosphere.

7. A liquid supply source comprising:
a liquid container portion that accommodates liquid inside; and
a liquid delivery portion that delivers the liquid outside, wherein
the liquid delivery portion is connected to an upstream side of the liquid supply flow passage in the liquid supply system according to claim 1.

8. A liquid ejecting apparatus comprising:
a liquid ejecting head that ejects liquid; and
the liquid supply system according to claim 1, wherein the liquid supply system supplies the liquid to the liquid ejecting head.
